(19) United States
(12) Patent Application Publication
(10) Pub. No.: US 2026/0228900 A1
(43) Pub. Date: Aug. 6, 2026

(54) REGION OF INTEREST GENERATION AT INFERENCE FOR PERCEPTION TASKS

(71) Applicant: QUALCOMM Incorporated, San Diego, CA (US)

(72) Inventors: Hazem Ahmed Mohamed Mohamed Rashed, Kronach (DE); Kiran Bangalore Ravi, Paris (FR); Julia Kabalar, München (DE); Sandeep Pandey, Waldenbuch (DE); Marvin Richard Klingner, Braunschweig (DE); Camille Maurice, München (DE); Nirnai Ach, Munich (DE); Senthil Kumar Yogamani, San Diego, CA (US)

(21) Appl. No.: 19/046,033

(22) Filed: Feb. 5, 2025

(51) Int. Cl. G06T 7/215; G01C 21/00; G06T 3/40; G06V 20/56; G06V 20/70

(52) U.S. Cl. CPC G06T 7/215; G01C 21/3874; G01C 21/3896; G06T 3/40; G06V 20/588; G06V 20/70; G06T 2207/20016; G06T 2207/20168; G06T 2207/30241; G06T 2207/30256

(57) ABSTRACT

An apparatus for performing a perception task includes a memory for storing sensor data and processing circuitry in communication with the memory. The processing circuitry is configured to obtain sensor data from one or more sensors corresponding to a scene in the vicinity of a vehicle. The apparatus detects objects in the scene using the sensor data and determines a first region of interest (ROI) based on a predicted trajectory of the vehicle. The apparatus also determines a second ROI based on the sensing range of the sensors. The first and second ROIs are merged to generate a combined ROI, which is used to perform one or more perception tasks. This apparatus enhances object detection and scene analysis, optimizing perception-based decision-making for vehicle navigation and safety applications.

### TECHNICAL FIELD

The disclosure relates to computer vision and perception tasks.

### BACKGROUND

Perception systems in autonomous vehicles may use Deep Neural Networks (DNNs) to predict a wide range of scene attributes. These attributes include 3D pose, object class, acceleration, tracking, trajectory, occlusion level and origin, visibility, and specialized cases such as traffic light color. Each of these tasks typically employs a dedicated DNN, resulting in concurrent execution that increases computational cost and may decrease overall system accuracy.

DNNs may provide scene attributes as output which are passed as input into Advanced Driver Assistance Systems (ADAS) for self-driving vehicles. Such DNNs enable the perception tasks used by an ADAS to interpret and interact with the environment. For instance, DNNs may process sensor data from cameras, LiDAR, radar, and ultrasonic sensors to detect and classify objects such as vehicles, pedestrians, and traffic signs. DNNs may perform tasks such as semantic segmentation, which label pixels in an image, and object detection, which identifies the types of objects and their locations within a scene.

### SUMMARY

In general, this disclosure describes processing techniques, including the processing of sensor data in a more efficient manner, especially for time-sensitive applications. For instance, computer vision applications, such as Advanced Driver Assistance Systems (ADAS), consume attribute determinations derived by neural networks (e.g., deep neural networks (DNNs)) to perform inference and perception tasks in real-time or near-real time.

To address the inefficiencies with conventional perception systems, a method and apparatus is described that initially performs object detection to detect objects within a large area based on sensor data, such as objects of a scene in a vicinity of a vehicle. The system and method next create a smaller region of interest (ROI), referred to as a combined ROI. The combined ROI is a combination of a local ROI based on an effective sensing range of one or more sensors of the vehicle and a dynamic ROI representing the possible path of the vehicle through the scene using contextual road data, such as lane width, number of lanes, direction of travel, etc. The system and method perform attribute processing on the previously detected objects which reside only within the smaller combined ROI without performing attribute processing for objects which reside outside of the smaller combined ROI, thus reducing overall computational resources utilized. In some examples, the smaller combined ROI is divided into multiple priority zones enabling selective attribute processing of some areas within the combined ROI with higher processing priority and other areas of the combined ROI with lower processing priority.

For instance, high priority processing may be selectively applied to objects of the scene in front of the vehicle, such that attribute processing derives all possible attributes for the previously detected objects corresponding to that area. Lower priority processing may be selectively applied to objects of the scene behind the vehicle, such that some attributes are derived, but fewer attributes than objects within the area in front of the vehicle which selectively receive high-priority processing.

The local ROI may define which regions are configured to receive higher and lower priority attribute processing. The local ROI may be merged with the dynamic ROI into the combined ROI which both reduces the area of the scene to which attribute processing is applied as well as indicates which areas of the scene are to receive higher or lower prioritized attribute processing. For instance, the combined ROI may specify or associate the areas of the scene in front of the ego-vehicle with higher priority processing due to their greater importance. Such higher importance regions may undergo further processing utilizing attribute processing neural networks to derive, for example, all configured attributes for previously detected objects which lie within the high priority areas. Conversely, areas of the scene behind the vehicle may be specified or associated with lower priority processing according to the combined ROI due to their relative lesser importance than the high priority areas of the scene. Previously detected objects which reside within the lower priority areas of the scene, according to the combined ROI, may receive some additional attribute processing by the neural networks, but rather than deriving all configured attributes for such objects in the lower priority areas, an orchestrator may specify that only a subset of configured attributes are to be derived for such objects to reduce the computational resources expended.

By concentrating computational resources for attribute processing on the more important and thus more contextually relevant regions of a scene, the system reduces overall processing demands, allocating more processing capabilities to previously detected objects with reside within higher importance areas and allocating lower processing priority to previously detected objects within the less important and less contextually relevant areas of the scene. In such a way, the system limits or entirely negates the execution of attribute processing by neural networks for objects in the scene within such the lower-priority zones freeing up additional computational resources for the neural networks deriving attributes from the higher priority areas, according to the configuration of the local ROI when merged with the dynamic ROI into the combined ROI. This selective processing enhances both speed and system efficiency and may also yield higher quality predictive output from the neural networks for the derived attributes from previously detected objects which reside within the higher priority areas and therefore benefit from greater computational processing allocations.

In one example, an apparatus for performing a perception task includes a memory for storing sensor data. The apparatus also includes processing circuitry in communication with the memory. In one example, the processing circuitry is configured to obtain sensor data from one or more sensors, where the sensor data corresponds to a scene in the vicinity of a vehicle. According to certain examples, the processing circuitry is configured to detect objects in the scene using the sensor data. In at least one example, the processing circuitry is configured to determine a first region of interest (ROI) based on a predicted trajectory of the vehicle through the scene. In another example, the processing circuitry is configured to determine a second ROI for the vehicle based on a sensing range of the one or more sensors. According to such examples, the processing circuitry is configured to merge the first ROI and the second ROI to generate a combined ROI. In at least one example, the processing circuitry is configured to perform one or more perception tasks using the combined ROI.

According to another example, a method of processing sensor data includes obtaining sensor data from one or more sensors, where the sensor data corresponds to a scene in the vicinity of a vehicle. In one example, the method includes detecting objects in the scene using the sensor data. According to certain examples, the method includes determining a first region of interest (ROI) based on a predicted trajectory of the vehicle through the scene. In at least one example, the method includes determining a second ROI for the vehicle based on a sensing range of the one or more sensors. According to such examples, the method includes merging the first ROI and the second ROI to generate a combined ROI. In one example, the method includes performing one or more perception tasks using the combined ROI.

In another example, this disclosure describes a non-transitory computer-readable medium storing instructions that, when executed, cause processing circuitry to obtain sensor data from one or more sensors, where the sensor data corresponds to a scene in the vicinity of a vehicle. In one example, the instructions cause the processing circuitry to detect objects in the scene using the sensor data. According to certain examples, the instructions cause the processing circuitry to determine a first region of interest (ROI) based on a predicted trajectory of the vehicle through the scene. In at least one example, the instructions cause the processing circuitry to determine a second ROI for the vehicle based on a sensing range of the one or more sensors. According to such examples, the instructions cause the processing circuitry to merge the first ROI and the second ROI to generate a combined ROI. In one example, the instructions cause the processing circuitry to perform one or more perception tasks using the combined ROI.

According to yet another example, there is a device that includes means for obtaining sensor data from one or more sensors, where the sensor data corresponds to a scene in the vicinity of a vehicle. In one example, the device includes means for detecting objects in the scene using the sensor data. According to certain examples, the device includes means for determining a first region of interest (ROI) based on a predicted trajectory of the vehicle through the scene. In at least one example, the device includes means for determining a second ROI for the vehicle based on a sensing range of the one or more sensors. According to such examples, the device includes means for merging the first ROI and the second ROI to generate a combined ROI. In one example, the device includes means for performing one or more perception tasks using the combined ROI.

This summary is intended to provide an overview of the subject matter described in this disclosure. It is not intended to provide an exclusive or exhaustive explanation of the systems, device, and methods described in detail within the accompanying drawings and description herein. Further details of one or more examples of the disclosed technology are set forth in the accompanying drawings and in the description below. Other features, objects, and advantages of the disclosed technology will be apparent from the description, drawings, and claims.

### BRIEF DESCRIPTION OF DRAWINGS

FIG. 1 is a block diagram illustrating an example processing system, in accordance with one or more techniques of this disclosure.

FIG. 2 is a block diagram illustrating an architecture for efficiently processing sensor data to perform inference and perception tasks, in accordance with one or more techniques of this disclosure.

FIG. 3 is a flow diagram illustrating a merged-mask generation process, in accordance with one or more techniques of this disclosure.

FIG. 4 is a diagram of an example dynamic mask, in accordance with one or more techniques of this disclosure.

FIG. 5 is a diagram of an example static mask, in accordance with one or more techniques of this disclosure.

FIG. 6 is a diagram of an example merged-mask, in accordance with one or more techniques of this disclosure

FIG. 7 is a flow diagram illustrating an example method for processing sensor data in a more efficient manner, in accordance with one or more techniques of this disclosure.

Like reference characters denote like elements throughout the description and figures.

### DETAILED DESCRIPTION

In general, this disclosure describes processing techniques, including the processing of sensor data in a more efficient manner, especially for time-sensitive applications. For instance, computer vision applications, such as Advanced Driver Assistance Systems (ADAS), consume attribute determinations derived by neural networks (e.g., deep neural networks (DNNs)) to perform inference and perception tasks in real-time or near-real time.

However, not all regions within a scene are equally important. For example, an object or vehicle detected behind the ego-vehicle is less relevant than an object directly in front of the ego-vehicle, as the ego-vehicle is less likely to interact with objects behind it, especially while operating in a forward direction of travel. A region of interest (ROI) can be defined to identify which detected objects are more important, enabling less important objects (e.g., less relevant objects) to receive lower priority for attribute processing, thus reducing processing requirements. Prior known systems apply attribute processing uniformly to objects detected within without regard to how relevant each given area of a scene is to the ego-vehicle. Prior known systems may also discard regions of the scene which are past a threshold distance from the ego-vehicle after performing attribute processing, effectively wasting computational resources associated with analyzing areas of the scene which are later discarded.

To address the inefficiencies with conventional perception systems, a method and apparatus is described that initially performs object detection to detect objects within a large area based on sensor data, such as objects of a scene in a vicinity of a vehicle. The system and method next create a smaller region of interest (ROI), referred to as a combined ROI. The combined ROI is a combination of a local ROI based on an effective sensing range of one or more sensors of the vehicle and a dynamic ROI representing the possible path of the vehicle through the scene using contextual road data, such as lane width, number of lanes, direction of travel, etc. The system and method perform attribute processing on the previously detected objects which reside only within the smaller combined ROI without performing attribute processing for objects which reside outside of the smaller combined ROI, thus reducing overall computational resources utilized. In some examples, the smaller combined ROI is divided into multiple priority zones enabling selective attribute processing of some areas within the combined ROI with higher processing priority and other areas of the combined ROI with lower processing priority.

For instance, high priority processing may be selectively applied to objects of the scene in front of the vehicle, such that attribute processing derives all possible attributes for the previously detected objects corresponding to that area. Lower priority processing may be selectively applied to objects of the scene behind the vehicle, such that some attributes are derived, but fewer attributes than objects within the area in front of the vehicle which selectively receive high-priority processing.

The local ROI may define which regions are configured to receive higher and lower priority attribute processing. The local ROI may be merged with the dynamic ROI into the combined ROI which both reduces the area of the scene to which attribute processing is applied as well as indicates which areas of the scene are to receive higher or lower prioritized attribute processing. For instance, the combined ROI may specify or associate the areas of the scene in front of the ego-vehicle with higher priority processing due to their greater importance. Such higher importance regions may undergo further processing utilizing attribute processing neural networks to derive, for example, all configured attributes for previously detected objects which lie within the high priority areas. Conversely, areas of the scene behind the vehicle may be specified or associated with lower priority processing according to the combined ROI due to their relative lesser importance than the high priority areas of the scene. Previously detected objects which reside within the lower priority areas of the scene, according to the combined ROI, may receive some additional attribute processing by the neural networks, but rather than deriving all configured attributes for such objects in the lower priority areas, an orchestrator may specify that only a subset of configured attributes are to be derived for such objects to reduce the computational resources expended. For instance, a stop light behind the ego-vehicle may turn from green to red, however, such information is of lesser importance to the ego-vehicle, and as such, the orchestrator specifies that such attributes need not be derived by the attribute processing neural networks.

By concentrating computational resources on the more important and thus more contextually relevant regions of a scene, the system reduces overall processing demands, allocating more processing capabilities to previously detected objects with reside within higher importance areas and allocating lower processing priority to previously detected objects within the less important and less contextually relevant areas of the scene. In such a way, the system limits or entirely negates the execution of attribute processing by neural networks for objects in the scene within such the lower-priority zones freeing up additional computational resources for the neural networks deriving attributes from the higher priority areas, according to the configuration of the local ROI when merged with the dynamic ROI into the combined ROI. This selective processing enhances both speed and system efficiency and may also yield higher quality predictive output from the neural networks for the derived attributes from previously detected objects which reside within the higher priority areas and therefore benefit from greater computational processing allocations.

Such a method and system resolves inefficiencies associated with prior known techniques which apply object detection and derivation of attributes for such objects without regard to the differing levels of importance each portion of a scene may hold, in terms of relevance, to the vehicle. Unlike prior techniques, the described method and system do not require the use of refined dynamic or multi-task neural networks that simultaneously predict attributes and 3D annotations. Instead, the techniques of this disclosure utilize conditional processing of attributes based on the local ROI that considers sensor ranges (which are static regardless of where the ego-vehicle is geographically) and dynamic scene information such as lane topology, road-type, and intersecting roads, as represented by a dynamic ROI, for evaluating potential interactions with detected objects.

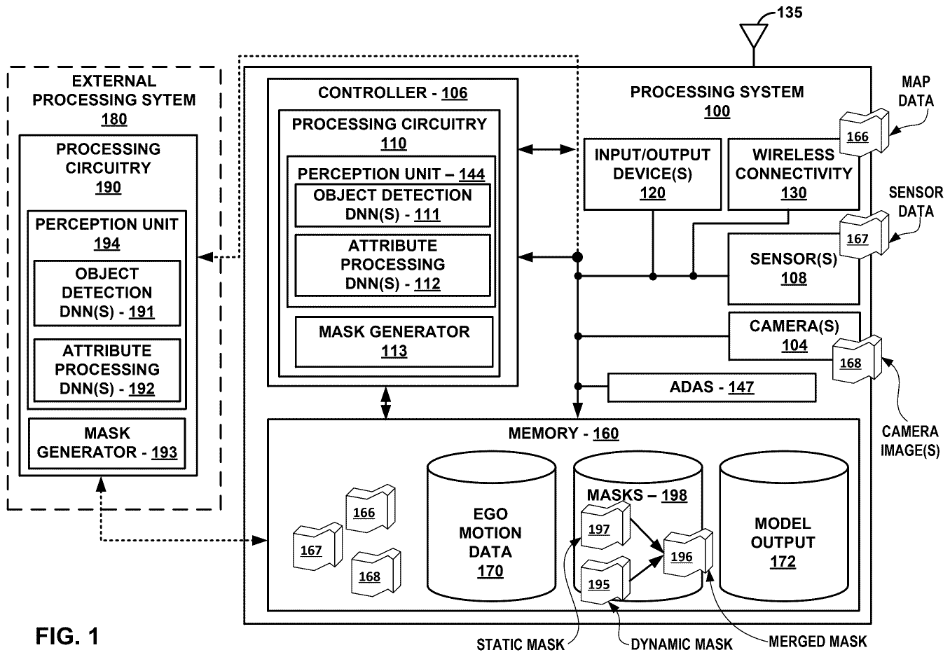

FIG. 1 is a block diagram illustrating an example processing system 100, in accordance with one to more techniques of this disclosure. Processing system 100 may be used in an apparatus, such as a vehicle, including an autonomous driving vehicle or an assisted driving vehicle (e.g., a vehicle having an advanced driver-assistance system (ADAS 147) or an “ego-vehicle”). In such an example, processing system 100 may represent ADAS 147 or operate in conjunction with ADAS 147. In other examples, processing system 100 may be used for other kinds of applications that may include sensors such as a camera and/or a LiDAR system. The techniques of this disclosure are not limited to vehicular applications. Rather, the techniques of this disclosure may be applied by any system that processes sensor data 167, including camera data and position data.

Processing system 100 may include camera(s) 104, controller 106, one or more sensor(s) 108, input/output device(s) 120, wireless connectivity component 130, and memory 160. Camera(s) 104 may be any type of camera configured to capture video or image data in the environment around processing system 100 (e.g., around a vehicle). In some examples, processing system 100 may include multiple cameras 104. For example, camera(s) 104 may include a front-facing camera (e.g., a front bumper camera, a front windshield camera, and/or a dashcam), a back-facing camera (e.g., a backup camera), side-facing cameras (e.g., cameras mounted in sideview mirrors). Camera(s) 104 may be a color camera or a grayscale camera. In some examples, camera(s) 104 may be a camera system including more than one camera sensor. Camera(s) 104 may, in some examples, be configured to collect camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., ADAS 147) configured to control operation of processing system 100 (e.g., including the operation of a vehicle) or may be configured to operate cooperatively with ADAS 147. For example, controller 106 may control acceleration, braking, and/or navigation of a vehicle through the environment surrounding the vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. As depicted here, DNNs include object detection DNN(s) 111 and attribute processing DNN(s) 112 within controller 106 and object detection DNN(s) 191 and attribute processing DNN(s) 192 of external processing system 180. An NPU may sometimes alternatively be referred to as a neural signal processor (NSP), a tensor processing unit (TPU), a neural network processor (NNP), an intelligence processing unit (IPU), or a vision processing unit (VPU).

Processing system 100 for an ego-vehicle may have a neural network, such as object detection DNN(s) 111 configured for the detection of objects within a scene based on data obtained from one or more sensors 108. Such object detection may be performed by dedicated object detection DNN(s) 111 regardless of where those objects physically reside within the scene. Other neural networks of perception unit 144, such as attribute processing DNN(s) 112, may be utilized to predict attributes on a configurable subset of the previously detected objects based on a combined ROI. For instance, an ego-vehicle may have multiple neural networks, such as specialized attribute processing DNNs 112, each specifically configured for detecting and interpreting various objects detected in the scene by object detection DNN(s) 111. Similarly, perception unit 194 of external processing system 180 may utilize dedicated object detection DNN(s) 191 and attribute processing DNN(s) 192.

Attribute processing DNNs 112, 192 may be specially tailored to extract specific attributes utilized for safe and efficient operation of the ego-vehicle. One such dedicated attribute processing DNNs 112, 192 might focus on traffic light recognition, not only identifying the presence of a stoplight but also determining, for example, its current state—red, yellow, or green—by analyzing pixel intensity, shape patterns, and temporal changes in its signal. Another attribute processing DNNs 112, 192 could be configured to classify traffic signs, such as distinguishing a yield sign from a stop sign, leveraging shape detection algorithms, edge recognition, and semantic interpretation of embedded symbols or text. For detecting vehicles that may be on a collision course, attribute processing DNNs 112, 192 for motion-prediction could process trajectory data, relative speed, and spatial proximity using inputs from LiDAR, radar, and cameras, predicting potential future positions. Similarly, attribute processing DNNs 112, 192 for pedestrian-detection DNN might identify vulnerable road users (VRUs) by recognizing human shapes, postures, and movements, even under occlusions or in low-visibility conditions.

A VRU refers to any individual on or near a roadway who is at a higher risk of injury or harm in the event of a collision with a vehicle, primarily due to their lack of physical protection compared to motorized vehicle occupants. The term VRU is typically used in reference to pedestrians, cyclists, motorcyclists, scooter riders, and individuals using personal mobility devices, such as wheelchairs or e-scooters. Identifying VRUs and attributes of VRUs may enable downstream applications, such as ADAS 147 to ensure safe operation through the application of specialized detection and prediction algorithms by neural networks to ensure the safety of VRUs detected within dynamic and complex traffic environments. In some examples, specialized attribute processing DNNs 112, 192 may be configured to derive a predicted intent for such VRUs, such as whether a pedestrian is predicted by attribute processing DNNs 112, 192 to step into an intersection.

Other types of attribute processing DNNs 112, 192 may specialize in lane boundary detection by analyzing road markings and their curvature or identifying drivable regions by segmenting the scene into road versus non-road areas. These specialized neural networks work together to build a comprehensive systematic interpretation of the scene, ensuring the ego-vehicle can navigate complex traffic scenarios safely and efficiently.

Processing circuitry 110 may also include one or more sensor processing units associated with camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., surrounding a vehicle). The one or more sensors may also include, for example, cameras, RADARs, and LiDARs, each with different fields of view (FOVs) and different effective ranges. The effective sensing range of each of the one or more sensor(s) 108 may be utilized to configure the local ROI or to systematically determine regions defined by the local ROI. Outputs of the one or more sensor(s) 108 may be correlated with the sensor data 167, such as being correlated with pixels, points, or bits corresponding to the locations within a static mask 197 from which the local ROI is determined.

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller may include a row decoder, column decoder, or both. In some cases, memory cells within memory 160 store information in the form of a logical state.

Processing system 100 may be configured to perform techniques for obtaining and storing sensor data 167, including data from the one or more sensor(s) 108 and/or from camera(s) 104 of processing system 100. Processing system 100 may be configured to extract sensor data 167 and position data from camera images 168. Processing system 100 may also be configured to process sensor data 167 obtained from one or more sensors 108, with such sensor data 167 corresponding to a scene in a vicinity of a vehicle. Processing system 100 may be configured to determine a dynamic region of interest (ROI) based on a predicted trajectory of the vehicle through the scene using and based on map data 166, determine a local ROI for the vehicle using an effective sensing range of the one or more sensor(s) 108, merge the dynamic ROI and the local ROI to generate a combined ROI, and determine attributes for one or more perception tasks from one or more objects previously detected within the combined ROI.

For instance, according to one example, processing system 100 determines attributes for one or more perception tasks for one or more of the objects previously detected within the combined ROI by applying a neural network (e.g., attribute processing DNN(s) 112 to the sensor data 167 to determine the attributes for the one or more perception tasks for one or more of the objects detected within the combined ROI.

The combined ROI defines a specific range around the ego-vehicle, but also accounts for the entire scene. For example, an object close to the ego-vehicle but located behind the ego-vehicle is less relevant, despite being part of the overall scene within which the ego-vehicle operates. If the combined ROI is designed too simplistically and merely highlights nearby objects, objects behind the ego-vehicle when operating in a forward direction of travel may prioritized processing due to close proximity with the ego-vehicle, even though such an object poses no realistic threat due to its position behind the ego-vehicle. Similarly, a combined ROI designed too simplistically and merely highlights objects near the ego-vehicle may overemphasize objects which are located outside of a roadway of travel for the vehicle, such as a commuter train located adjacent the roadway, or objects that have a low likelihood of interaction with the ego-vehicle, such as median barriers lining a roadway but outside of the permissible lanes of travel for the ego-vehicle.

A dynamic ROI, which evaluates the context of the scene, such map data 166 describing roads within the scene, can be used to reduce processing applied to objects in the scene by eliminating areas of the scene which are less relevant, such as objects within the scene which are located on a non-intersecting road relative to the vehicle or on an intersecting road beyond a threshold distance relative to the vehicle. The dynamic ROI will be different at different points in time due to the vehicle moving through a scene. For instance, according to one example, two ROIs may be utilized, both a first and a second ROI, or a dynamic ROI and also a local ROI. According to such an example, the first ROI is a dynamic ROI corresponding to a first field of view (FOV) of the one or more sensors at a first point in time which is different than a different dynamic ROI corresponding to a second FOV of the one or more sensors at second point in time. For example, a current dynamic ROI may be utilized which is different from a prior dynamic ROI at a different point in time (e.g., such as prior to the point in time for the current dynamic ROI). According to another example, the second ROI for the vehicle is a local ROI which is unchanged between the first point in time and the second point in time. Stated differently, the local ROI utilized at the first point in time with the current dynamic ROI is the same local ROI (e.g., it is unchanged) as a local ROI which was utilized at the second point in time with the prior dynamic ROI. In such a way, a different dynamic ROI may be used at each different point in time, whereas the same local ROI may be reused over and over again. Continuing with such an example, determining the first ROI based on the predicted trajectory of the vehicle through the scene may include creating a dynamic mask from the dynamic ROI, creating a static mask from the local ROI, and creating a merged-mask corresponding to the combined ROI from regions of the dynamic ROI and the local ROI which are included within both the dynamic mask and the static mask.

According to aspects of the disclosure, a local ROI, which is based on effective range of the one or more sensor(s), may also enable a reduction in processing time by assigning lower priority to less relevant areas of the scene. This approach allows object detection DNN(s) 111 to account for the entirety of a scene while prioritizing computational resources for attribute processing DNN(s) 112 to objects detected in the most relevant regions based on a combined ROI which is formed from the merger of a dynamic ROI with the local ROI.

A downstream application, such as an Advanced Driver Assistance Systems (ADAS) 147, may utilize the objects detected and the attributes derived for those objects to control a vehicle. ADAS 147 refers to a suite of technologies integrated into vehicles to enhance safety and improve driving performance by assisting a driver and/or automating specific driving tasks. ADAS 147 may utilize the objects detected and the attributes derived for those objects to monitor the vehicle's surroundings, assess potential hazards, and provide warnings or take corrective actions. Examples of ADAS 147 features include adaptive cruise control, lane departure warning, automatic emergency braking, blind-spot detection, traffic sign recognition, and parking assistance. Application of ADAS 147 utilizing the objects detected and the attributes derived for those objects may reduce the likelihood of accidents, minimize the severity of collisions, and enhance the overall driving experience.

As depicted here, memory 160 may store map data 166, sensor data 167, and camera images 168. Map data 166 may include, for example, high-definition (HD) maps that provide detailed road information, such as lane boundaries, road curvature, and the location of stop signs, traffic lights, or speed limits. Map data 166 may be stored locally within memory 160 and may be updated from time to time utilizing over-the-air (OTA) updates. In some examples, map data 166 may be a database that provides digitized map information. For instance, map data 166 may provide a queryable database from which digitized map information may be retrieved based on, for example, geographic coordinates or an address. In one example, map data 166 is an OpenStreetMap (OSM) database. OSM is a collaborative, open-source geographic database that provides detailed, editable maps created by a global community of contributors. It includes spatial data such as roads, buildings, rivers, and points of interest, stored in a structured, accessible format for use in navigation, geographic analysis, and app development. In another example, map data 166 is a Wikimapia database which combines mapping with wiki-style user edits. In yet another example, map data 166 is a queryable database for the Natural Earth public domain dataset which provides high-quality geospatial information for cartography and GIS applications.

Unlike map data 166 which is known a priori, sensor data 167 represents real-time or near-real-time inputs from one or more sensor(s) 108 such as cameras, LiDAR, or radar configured for the vehicle. For instance, sensor data 167 may indicate that a camera detects the red light of a stoplight, whereas radar could measure the distance to a leading vehicle, and LiDAR may precisely indicate the contours of a cyclist riding nearby.

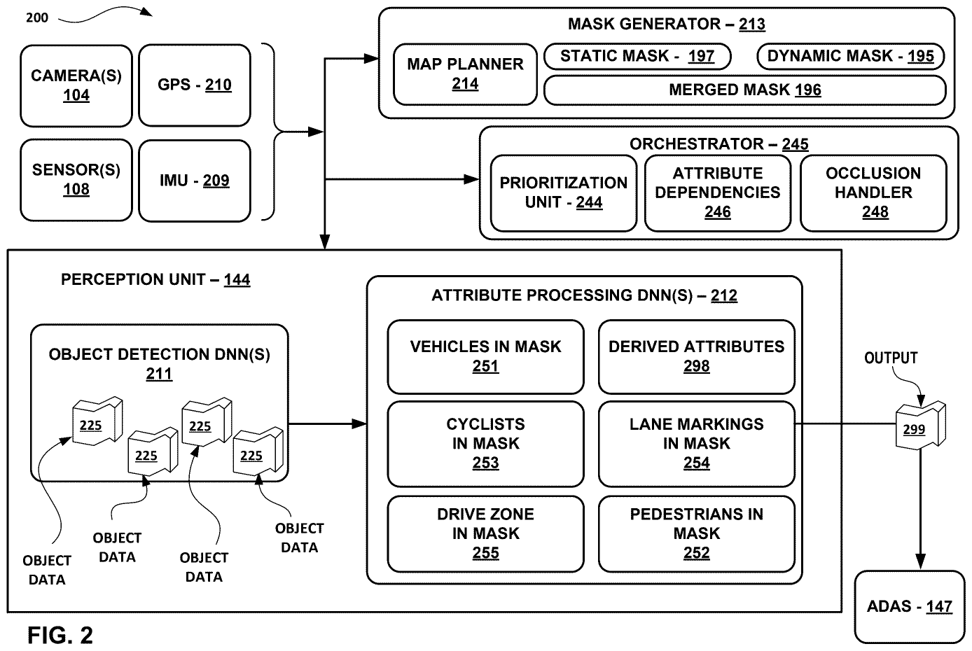

Memory 160 may also store ego-motion data 170 and model output 172, such as output provided by object detection DNN(s) 111, 191 and attribute processing DNN(s) 112, 192. Ego-motion data 170 refers to information that describes the movement and orientation of the ego-vehicle within its environment. Ego-motion data 170 may include parameters such as the vehicle's velocity, acceleration, angular velocity, and trajectory over time. Ego-motion data 170 may be derived from one or more sensor(s) such as inertial measurement units (IMUs) 209 (see FIG. 2), wheel encoders, GPS 210 (see FIG. 2), and optionally visual odometry from cameras. Ego-motion data 170 enables systematic interpretation of the ego-vehicle's position and dynamics relative to the surrounding world, enabling downstream tasks such as path planning, collision avoidance, and maintaining accurate localization within a map. For example, ego-motion data 170 may indicate the precise rate of a vehicle's turn while navigating a curve or its forward acceleration when approaching an intersection.

Also depicted, are masks 198 stored within memory 160, including static mask 197 created from a local ROI, dynamic mask 195 created from a dynamic ROI, and merged-mask 196 created from a combined ROI. For example, mask generator 113 may generate masks 198 and store masks 198 into memory 160, including generating static mask 197, dynamic mask 195, and merged-mask 196.

As depicted here, processing circuitry 110 may include perception unit 144 and mask generator 113. Depicted within perception unit 144 are each of object detection DNN(s) 111 and attribute processing DNN(s) 112. Each of perception unit 144, mask generator 113, object detection DNN(s) 111, 191 and attribute processing DNN(s) 112, 192 may be implemented in software, firmware, and/or any combination of hardware described herein. Each of perception unit 144, mask generator 113, object detection DNN(s) 111, 191 and attribute processing DNN(s) 112, 192 may be configured to receive or obtain sensor data 167 from sensor(s) 108 and/or camera images 168 captured by camera(s) 104. Each of perception unit 144, mask generator 113, object detection DNN(s) 111, 191 and attribute processing DNN(s) 112, 192 may be configured to obtain sensor data 167 directly from sensor(s) 108 and/or camera images 168 directly from camera(s) 104, or be configured to obtain sensor data 167 and/or camera images 168 from memory 160. In some examples, sensor data 167 may be derived from camera images 168 and may be referred to herein as “image data.” In other examples, sensor data 167 is obtained as raw or post processed data from one or more sensors 108. Moreover, sensor data 167 may be derived from static images, video imagery, a video stream, LiDAR data, radar data, IMU data, sensor 108 output, or some combination thereof.

Mask generator 113 may generate a dynamic ROI that considers the current geographical position of the ego-vehicle (e.g., the current road traveled by the ego-vehicle and nearby interacting roads) as well as a local ROI that defines static zones around a vehicle using relevant effective sensor ranges for the one or more sensor(s) 108. By distinguishing regions of interest around the ego-vehicle using local ROI (e.g., in front of the vehicle, behind the vehicle, etc.), mask generator 113 merges the local ROI and dynamic ROI to create combined ROI. The combined ROI may be utilized by orchestrator 245 (see FIG. 2) to dynamically and selectively apply higher or lower attribute processing priority to each area, also referred to as conditional processing.

Perception unit 144 enables processing circuitry 110 to perform perception tasks. In the context of computer vision for applications such as Advanced Driver Assistance Systems (ADAS) 147, perception tasks by perception unit 144 enable ADAS 147 to more safely control a vehicle by the detection, classification, and tracking of objects in within the environment surrounding the vehicle, with such detected objects including pedestrians, other vehicles, road signs, and obstacles. Perception tasks performed by perception unit 144 may include object detection, semantic segmentation, lane detection, and depth estimation, using cameras 104 and/or sensors 108 such as LiDAR, and radar sensors. Real-time processing of sensor data 167 enables ADAS 147 to better systematically interpret vehicle surroundings and make computational vehicle control decisions for navigation and safety. Machine learning algorithms, particularly deep learning techniques such as those applied by object detection DNN(s) 111, 191 and attribute processing DNN(s) 112, 192, enable more accurate and reliable perception tasks by perception unit 144, thus enabling ADAS 147 to better predict potential hazards and react more appropriately. Use of perception unit 144 to perform reliable perception tasks helps to ensure a more seamless and safe driving experience by ADAS 147 and fully autonomous and semi-autonomous vehicles.

Object detection DNN(s) 111, 191 and attribute processing DNN(s) 112, 192 may interpret complex data including sensor data 167 from sensors 108 and camera images 168 (e.g., image data or visual data) from cameras 104. Neural networks, including convolutional neural networks (CNNs), such as object detection DNN(s) 111, 191 and attribute processing DNN(s) 112, 192, may be configured to handle tasks such as object detection, classification, and segmentation by learning hierarchical features from raw sensor data 167, including images and video. Object detection DNN(s) 111, 191 and attribute processing DNN(s) 112, 192 may be trained on large datasets to recognize and differentiate objects such as pedestrians, vehicles, road signs, and obstacles. Object detection DNN(s) 111, 191 and attribute processing DNN(s) 112, 192 serve distinct but complementary roles in support of the system and method described. Object detection DNN(s) 111, 191 are specialized in identifying and localizing objects in a scene without need to expend computational resources to the derivation of detailed attributes about those objects. Object detection DNN(s) 111, 191 may output bounding boxes or segmentation masks to indicate the presence and position of objects detected in a scene utilizing sensor data 167. In such an example, object detection DNN(s) 111, 191 may perform pre-processing operations using sensor data 167 to establish “what” objects reside within the scene and “where” such objects are located in the scene. Attribute processing may then be selectively applied to a portion of the previously detected objects via subsequent downstream processes.

In contrast, attribute processing DNN(s) 112, 192 are configured to provide more detailed attribute information about the objects detected by object detection DNN(s) 111, 191 and are therefore alleviated of the computational burden of initial object detection performed during prior processing. Such a delineation may be helpful for real-time and near-real-time processing as the distinct and specialized object detection DNN(s) 111, 191 and attribute processing DNN(s) 112, 192 may operate more efficiently than generalized neural networks for perception tasks and also facilitate the bifurcation of perception tasks into initial object detection by specialized object detection DNN(s) 111, 191 during preprocessing and subsequent attribute derivation by attribute processing DNN(s) 112, 192 during the subsequent downstream operations.

Attribute processing DNN(s) 112, 192 may accept as input, the output provided from object detection DNN(s) 111, 191 specifying one or more objects detected in a scene. As the name suggests, attribute processing DNN(s) 112, 192 are enabled to derive specific attributes and characteristics of previously detected objects, enabling a richer and more nuanced systematic interpretation of the scene. For instance, object classification by attribute processing DNN(s) 112, 192 may involve distinguishing between specific types of vehicles, such as a sedan versus a truck, or identifying subcategories of vulnerable road users such as cyclists versus motorcyclists. Object properties extraction, as performed by attribute processing DNN(s) 112, 192, may enable the determination of intrinsic features such as the color of a vehicle, the texture of a road surface, or the material of a traffic barrier. Pose and orientation estimation operations performed by attribute processing DNN(s) 112, 192 involves determining an object's position and alignment in 3D space, such as calculating the angle of a vehicle's turn or the direction a pedestrian is facing.

In some examples, attribute processing DNN(s) 112, 192 may infer an object's state, such as recognizing whether a car door is open or closed or identifying the status of a pedestrian signal on a crosswalk light. Action or behavior analysis performed by attribute processing DNN(s) 112, 192 enables the determination of dynamic activities such as a person walking, a cyclist braking, or a vehicle accelerating. Attribute processing DNN(s) 112, 192 derive semantic relationships by inferring connections between objects in the scene, such as determining that a pedestrian is waiting near a crosswalk. Fine-grained recognition by attribute processing DNN(s) 112, 192 derives more subtle distinctions within categories, such as distinguishing between different brands or models of vehicles.

For objects related to faces, sentiment or expression analysis by attribute processing DNN(s) 112, 192 may identify emotional states such as happiness or concern, while functional attributes focus on inferring the intended use or purpose of a previously detected object, such as recognizing that a traffic cone is placed to signal a road hazard. Localization attributes may be derived by attribute processing DNN(s) 112, 192 to provide a deeper spatial interpretation of a scene by predicting key points or contours, such as mapping skeletal structures in humans or defining mechanical components in construction equipment.

Output from object detection DNN(s) 111, 191 and analysis by attribute processing DNN(s) 112, 192 may enable perception unit 144 to perform 3D Object Detection (3DOD) TLR (Traffic Light Recognition) and TSR (Traffic Sign Recognition) as computer vision perception tasks for ADAS 147. TLR detects and classifies traffic lights, while TSR identifies road signs. Both utilize 3D perception to inform ADAS 147 of the environment surrounding a vehicle and to and facilitate navigation decisions by ADAS 147. In ADAS 147 and other computer vision applications, object detection DNN(s) 111, 191 and attribute processing DNN(s) 112, 192 enhance vehicle perception, enabling real-time decision-making for navigation, safety, and obstacle avoidance. Perception unit 144, 194 may apply object detection DNN(s) 111, 191 and attribute processing DNN(s) 112, 192 to interpret an environment surrounding a vehicle, to predict future movements of the vehicle, to predict future movements of objects within a scene in proximity to the vehicle, and to adapt to other dynamic conditions present within the environment surrounding the vehicle.

Mask generator 113 may generate masks 198 corresponding to defined regions of interests (ROIs), including iteratively generating static masks 197, dynamic masks 195, and merged-masks 196. For instance, mask generator 113 may iteratively generate a current frame mask corresponding to merged-mask 196 for every processing frame of camera images 168 and/or every processing cycle of sensor data 167. Mask generator 113 may generate masks 198 corresponding to other configurable intervals. Such intervals may be configured depending on the implementation and the type(s) of sensor data 167 utilized. For instance, camera images 168 may be generated less frequently than, for example, inertial measurement unit (IMU) data and LiDAR data. Therefore, a processing cycle for a current frame mask may correspond to some period of time (e.g., 1-second or 0.5 seconds), some quantity of processor clock cycles (e.g., every 100 clock cycles or 1000 clock cycles, etc.), some periodic frequency of frames sampled from a video stream (e.g., every 5 frames or 50 frames of video), or some other useful interval. Mask generator 113 may transform ROIs into local coordinate systems to facilitate the generation of masks 198. For instance, mask generator 113 may transform a dynamic mask 195 for a scene in a vicinity of a vehicle into a local coordinate system and may merge a static mask 197 into a local coordinate system. Alternatively, mask generator 113 may transform a dynamic mask 195 of a scene in a vicinity of a vehicle into a local coordinate system, transform a static mask 197 in static proximity to a vehicle into another local coordinate system, and merge the two coordinate systems to create merged-mask 196. Mask generator 113 may determine the dynamic ROI from the coordinate system of the dynamic mask 195 and may determine the local ROI from the static mask 197. Mask generator 113 may merge the local ROI and the dynamic ROI into a combined ROI. Mask generator 113 may also generate a combined ROI formed from the combination of the local ROI and the dynamic ROI to discard portions of the scene or to discard portions of the dynamic ROI from a local coordinate system corresponding to the merged-mask 196. For instance, when creating a combined ROI from a local ROI and a dynamic ROI, portions of the dynamic ROI which are outside of any defined zones of the local ROI may be discarded. For instance, mask generator 113 may discard portions of the dynamic ROI from the local coordinate system which lack a shared coordinate position with the local ROI merged into the local coordinate system to reduce processing burdens on processing circuitry 110, to facilitate more efficient processing, and to allocate a greater share of processing capacity to a higher priority zone defined by the merged-mask 196. For instance, a zone in front of a vehicle may have a higher priority processing allocation than a zone behind a vehicle. Similarly, a zone beyond a sensing range of the sensors may be allocated lower priority processing or may be discarded from processing entirely based on the merged-mask 196 created by mask generator 113.

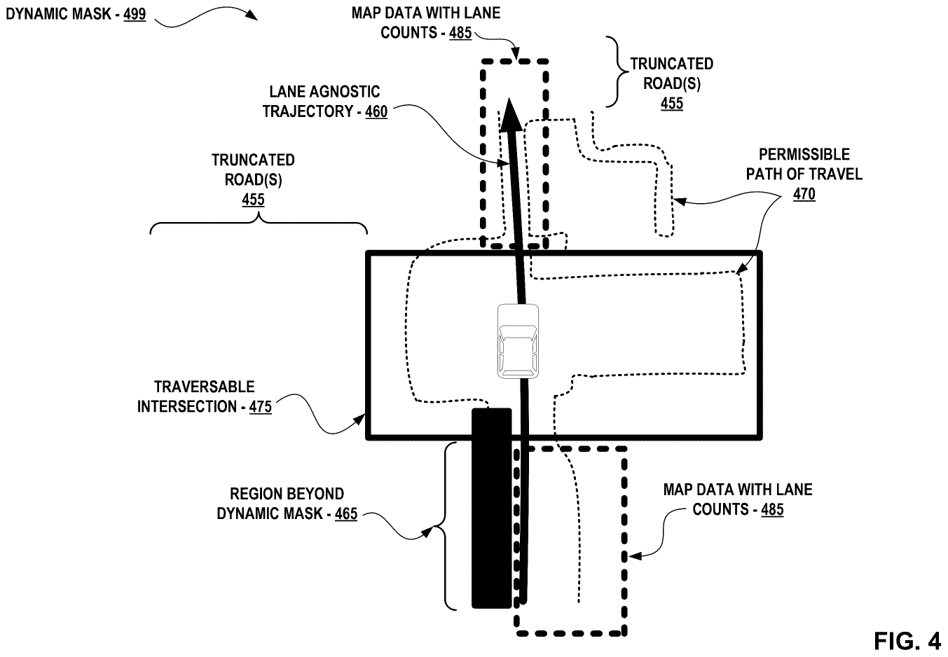

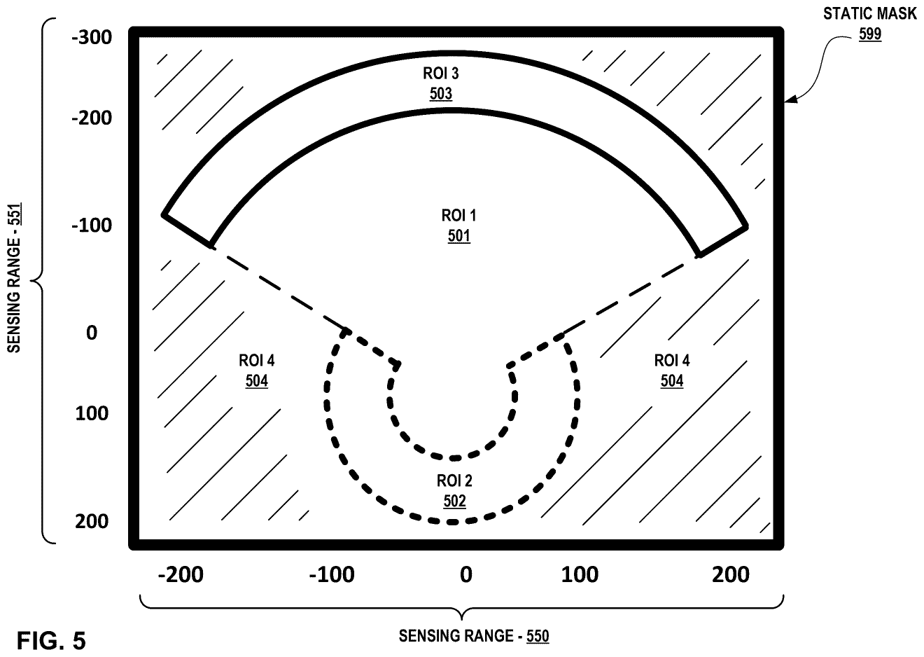

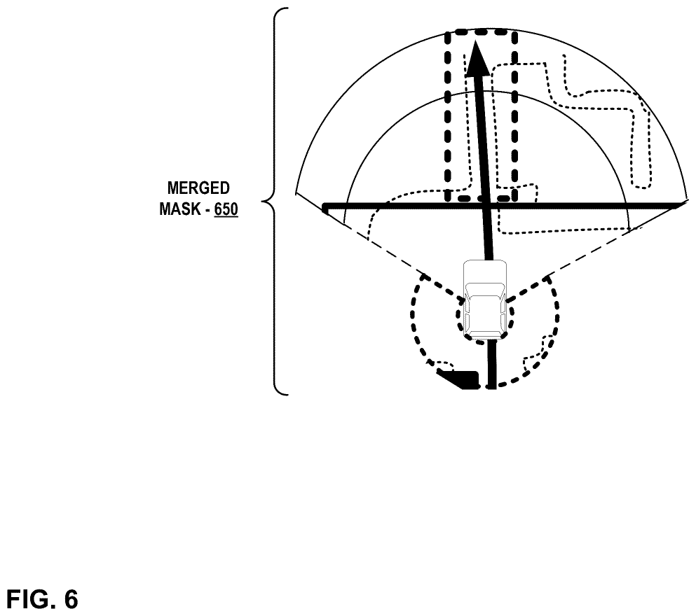

Mask generator 113 is configured to generate the masks that define the ROIs. Mask generator 113 may generate dynamic mask 195 which defines various dynamic road contexts, such as permissible lanes of travel, lane type, intersecting roads as depicted at FIG. 4 and described in additional detail below. Mask generator 113 may determine a dynamic ROI from dynamic mask 195. Mask generator 113 may generate static mask 197 which defines various zones of processing priority as depicted at FIG. 5 and described in additional detail below. Mask generator 113 may determine a local ROI from static mask 197. Mask generator 113 may define merged-mask 196 from points, pixels, bits, or locations which are common (e.g., shared) by both dynamic mask 195 and static mask 197 as depicted at FIG. 6 and described in additional detail below. Mask generator 113 may determine a combined ROI from merged-mask 196. Mask generator 113 may pass merged-mask 196 and/or a combined ROI to orchestrator 245 (see FIG. 2) for use in configuring selective processing of previously detected objects which are located within the various zones of a combined ROI.

Selective attribute processing may subsequently be applied to previously detected objects within the various zones by orchestrator 245 (see FIG. 2) which passes objects which are located within the combined ROI to attribute processing DNN(s) 112, 192 along with an indication processing priority for the objects. In such an example, mask generator 113 may output from such pre-processing operations, merged-mask 196 in 3D space formed by merging dynamic mask 195 with static mask 197 to create merged-mask 196, where objects within merged-mask 196 are selectively prioritized with higher processing priority or lower processing priority, and objects outside of merged-mask 196 are allocated no attribute processing whatsoever or discarded entirely. For instance, an object outside of a threshold distance on an intersecting road within dynamic mask 195 and thus is not represented within merged-mask 196, may be tracked, but allocated no attribute processing such that no attributes are derived from the object due to its location outside of merged-mask 196. Optionally, objects which are located within merged-mask 196 may be selectively allocated low priority processing to derive fewer attributes than objects within high priority processing zones or may be allocated zero priority attribute processing, notwithstanding their presence within merged-mask 196. Mask generator 113 is described in greater detail below with an example of combining masks using a bitwise AND operation.

Based on how the zones of the local ROI are configured, orchestrator 245 (see FIG. 2) can allocate processing priority differently to objects detected within each region. For instance, more attributes or all attributes may be derived for objects within a high-priority zone (e.g., a zone which lies directly in front of a vehicle), whereas a fewer attributes may be derived for a lower priority zone (e.g., a zone which lies behind a vehicle).

Lift, Splat, Shoot (LSS) operations may be utilized to generate estimated depth distributions based on camera features generated from camera images 168 and/or sensor data 157. According to some examples, object detection may be performed in a BEV (Bird's Eye View) representation. A BEV representation in the context of ADAS 147 and computer vision refers to a top-down, 360-degree view of the vehicle's surroundings. This is achieved by combining data from multiple cameras placed around the vehicle. BEV assists in navigation, parking, and obstacle detection by providing a clear, intuitive representation of the environment from above. A BEV representation enhances safety by offering drivers better awareness of nearby objects or pedestrians. BEV is commonly used in parking assist systems and other advanced driver assistance features to help with low-speed maneuvering and avoiding collisions.

Within the context of computer vision as applied to the control of vehicles, such as within ADAS 147 type processing system 100, reduction of processing latency delays and computationally efficient operation may enable more accurate and more responsive vehicle control and overall improved predictive output by object detection DNN(s) 111, 191 and attribute processing DNN(s) 112, 192 and improved perception task output by perception unit 144.

In some examples, processing circuitry 110 may be configured to train one or more machine learning models such as encoders, decoders, positional encoding models, or any combination thereof applied by perception unit 144 using available training data. For example, training data may include sensor data 167 and/or one or more training camera images 168 along with ground truth data from a range sensor such as a LiDAR sensor. Such training data may additionally or alternatively include features known to accurately represent one or more point cloud frames and/or features known to accurately represent one or more camera images. This may allow processing circuitry 110 to train an encoder to generate features that accurately represent camera images 168 and or sensor data 167 from the sensors 108.

According to one example, the processing system 100 is part of an advanced driver assistance system (ADAS). According to such an example, processing system 100 (see FIG. 1) is further configured to output, from a neural network, the attributes to the ADAS configured to at least partially control the vehicle using the attributes.

Processing circuitry 110 of controller 106 may apply controller 106 to control a vehicle utilizing model output 172. Model output 172 represents the objects as output stored in memory 160 from object detection DNN(s) 111 and 191 and the attributes output from attribute processing DNN(s) 112, 192. For instance, object detection DNN(s) 111 and 191 may output bounding boxes and coordinates within the scene, such as model output 172 indicating an object at position (50, 50, 200, 200) with 0.98 confidence. The numbers (50, 50, 200, 200) define a bounding box specified with model output 172, where (50, 50) is the top-left corner and (200, 200) is the bottom-right corner. For example, an object may be detected at these coordinates 0.98 confidence, which may subsequently be utilized by a downstream task to perform operations such as braking or triggering alert responses. Similarly, attribute processing DNN(s) 112, 192 may output attributes which are stored in memory 160 as model output 172, such as a “Pedestrian” at position (300, 400, 500, 600) with 0.95 confidence. Attribute processing DNN(s) 112 and 192 may further refine certain objects, in the manner discussed above, and store those refinements as model output 172, such as classifying a car as a “Red,” “SUV,” and “Parked,” while describing a pedestrian as “Walking” in a “Blue Jacket.” Model output 172 may include predicted trajectories, an identity of one or more objects, a position of one or more objects relative to vehicle, characteristics of movement (e.g., speed, acceleration) of one or more objects, or any combination thereof. Model output 172 enables real-time and/or near-real-time decision-making for downstream applications, such as ADAS 147, including tasks such as obstacle avoidance and path planning. Controller 106 in conjunction with ADAS 147 may control the vehicle based on information stored in memory 160 as model output 172, as generated and output by object detection DNN(s) 111, 191 and attribute processing DNN(s) 112, 192 relating to one or more objects within a 3D space.

The techniques of this disclosure may also be performed by external processing system 180. That is, performing perception tasks using perception unit 194, creating masks 198 using mask generator 193, and generating model output 172 using object detection DNN(s) 191 and attribute processing DNN(s) 192, may be performed by a processing system that does not include the various sensors shown for processing system 100. Such a process may be referred to as “offline” data processing, where the output is determined from sensor data 167 and/or camera images 168 received from processing system 100. External processing system 180 may send an output to processing system 100 (e.g., an ADAS 147 or vehicle).

While perception unit 144, mask generator 113, object detection DNN(s) 111 and attribute processing DNN(s) 112 are depicted as part of processing circuitry 110 for controller 106, each of perception unit 194, mask generator 193, object detection DNN(s) 191 and attribute processing DNN(s) 192 may optionally be included within processing circuitry 190 for external processing system 180. For instance, perception unit 194, mask generator 193, and/or object detection DNN(s) 191 and attribute processing DNN(s) 192 may be included within external processing system 180 for computer vision operations which are less time-sensitive, more computationally burdensome, or generally more resilient to operational latencies. In other examples, perception units 144, 194, mask generators 113, 193, and object detection DNN(s) 111, 191 and attribute processing DNN(s) 112, 192 are included in both processing circuitry 110 of controller 106 and also within external processing system 180 respectively, thus enabling certain computer vision tasks to be performed offline, off-loaded into the cloud, and/or performed by other remote external processing system 180 with low-latency operations being performed locally by processing system 100.

External processing system 180 may include processing circuitry 190, which may be any of the types of processors described above for processing circuitry 110. Processing circuitry 190 may acquire sensor data 167 from sensors 108 and/or camera images 168 from camera(s) 104, respectively, or from memory 160. Though not shown, external processing system 180 may also include a memory that may be configured to store map data 166, sensor data 167, camera images 168, model outputs 172, and masks 198, among other data that may be used in data processing. Controller 106 may be configured to perform any of the techniques described as being performed by controller 106 including the creation of merged-mask 196 representing a combined ROI by mask generator 113, 193 and the generation and output of predictive model output 172 by object detection DNN(s) 111, 191 and attribute processing DNN(s) 112, 192.

FIG. 2 is a block diagram illustrating an architecture 200 for efficiently processing sensor data 167 to perform inference and perception tasks, in accordance with one or more techniques of this disclosure. FIG. 2 includes perception unit 144 to perform object detection utilizing object detection DNN(s) 211 and to derive attributes utilizing attribute processing DNN(s) 212. Attribute processing DNN(s) 212 generates derived attributes 298 which are provided as output 299 to ADAS 147, for instance, to control a vehicle.

As depicted at FIG. 2, camera(s) 104, sensor(s) 108, GPS 210, and IMU 209, may provide inputs to mask generator 213 for use by map planner 214, as well as provide inputs into perception unit 144 and orchestrator 245. GPS 210 (Global Positioning System) is a component that determines a vehicle location using signals from multiple satellites. IMU 209 (Inertial Measurement Unit) is a specific type of sensor that measures acceleration, rotation, and orientation, providing data for navigation and motion tracking. Mask generator 213 may apply map planner 214 to map data and real-time sensor data 167 to plan a path for the vehicle. Map planner 214 may integrate maps remotely obtained or locally downloaded map data (e.g., digital high-definition maps of various geographic regions) with real-time sensor data 167 inputs from sensors 108 like cameras 104, LiDAR, and radar, helping the vehicle navigate accurately. As described above, map data 166 may be a queryable map database, such as OpenStreetMap (OSM) queryable map database, a Wikimapia queryable map database or a queryable map database for the Natural Earth public domain dataset. Such map databases are widely used in navigation, route planning, and geospatial analysis. In the context of computer vision applications such as ADAS, queryable map databases facilitate mapping of road networks, landmarks, and infrastructure, supporting safe and efficient vehicle navigation. Map planner 214 helps in route optimization, obstacle avoidance, and safe maneuvering in complex driving environments, ensuring the vehicle follows a planned trajectory while adjusting for dynamic changes, such as traffic conditions or road closures.

According to one example, the processing system 100 (see FIG. 1) is configured to apply higher-priority processing for one or more regions of interest within the scene, such as along a predicted trajectory of the vehicle through the scene where the vehicle satisfies a likelihood threshold of interacting with the scene. According to such an example, processing system 100 (see FIG. 1) may be configured to apply lower-priority processing for one or more regions of interest within the scene, such as an area behind the vehicle when operating in a forward direction.

As depicted by FIG. 2, perception unit 144 may perform object detection utilizing object detection DNN(s) 211. Object detection is a perception task in computer vision that includes detecting, identifying, and locating objects within sensor data 167 (see FIG. 1) from sensor(s) 108. Such information may include, for example, information obtained from LiDAR sensor(s) 108, radar sensor(s) 108, IMU 209 type sensor data 167, GPS 210 type sensor data 167, or sensor data 167 derived from camera(s) 104, such as images or video frames. Object detection DNN(s) 211 may not only classify objects (e.g., cars, pedestrians, traffic signs) but also determine their position by drawing bounding boxes around them. As depicted here, object detection DNN(s) 211 indicates the presence of objects within a scene, detected based on sensor data 167 (see FIG. 1). For instance, object detection DNN(s) 211, to the extent they are trained to detect a certain type of object, indicates that an object is present and labels where the object is within the scene within a bounding box. Object detection DNN(s) 211 may provide object data 225 to attribute processing DNN(s) 212 for further attribute processing.

Object detection DNN(s) 211 are utilized by downstream applications, such as ADAS 147 for the purposes of controlling a vehicle in an assisted driving or autonomous driving context, where detecting obstacles, vehicles, pedestrians, and traffic signals enables safe navigation. Objects detected by object detection DNN(s) 211 are additionally provided to attribute processing DNN(s) 212, to extract additional attributes, as described in greater detail above with reference to attribute processing DNN(s) 112, 192, of FIG. 1. Performance of object detection by object detection DNN(s) 211 may be evaluated based on accuracy (correctly identifying objects) and precision (precisely locating objects). When consumed by downstream applications such as ADAS 147, the output of object detection DNN(s) 211 and attribute processing DNN(s) 212 enables programmatic situational awareness for ADAS 147 in control of a vehicle and providing, for example, collision avoidance and safe navigational decision-making through a dynamic environment.

Mask generator 213 as depicted by FIG. 2 and briefly described above may iteratively generate merged-masks 196 corresponding to a combined ROI for some interval, such as every processing frame of camera images 168, every processing cycle of sensor data 167, a time-based interval, an interval based on an N quantity of processor clock cycles, an interval corresponding to a frequency of frames sampled from a video stream, or some other useful interval. For instance, merged-mask 196 may be formed from the combination or merging of static mask 197 with dynamic mask 195. As described above, mask generator 213 may transform a dynamic mask 195 for a scene in a vicinity of a vehicle into a local coordinate system and may merge a static mask 197 into a local coordinate system. Mask generator 213 may transform a dynamic mask 195 of a scene in a vicinity of a vehicle into a local coordinate system, transform a static mask 197 in static proximity to a vehicle into another local coordinate system, and merge the two coordinate systems to create merged-mask 196. Mask generator 213 may determine the dynamic ROI from the coordinate system of the dynamic mask 195 and may determine the local ROI from the static mask 197. Mask generator 213 may merge the local ROI and the dynamic ROI into a combined ROI. Mask generator 213 may discard portions of the dynamic ROI from the local coordinate system for any pixel, point, region, or location of the dynamic ROI which lacks a shared coordinate position with the local ROI as merged into the local coordinate system. Mask generator 213 may also output the local coordinate system having the portions of dynamic ROI discarded as merged-mask 196.

For instance, an area in front of the vehicle may have the highest processing priority according to the combined ROI. Map data 166, such as OpenStreetMaps (OSM) data are incorporated and represented by the dynamic ROI based on a geographic location coincident with the ego-vehicle. The future positions of the ego-vehicle are predicted using a motion model and previous poses and map planner 214 then provides a predicted trajectory which is utilized to compute a combined ROI based on the combination of the dynamic ROI having the integrated map data 166 and a local ROI created based on sensing ranges of one or more sensor(s) 108 of the vehicle. For example, map planner 214 may obtain, as input, one or more previous poses of the ego-vehicle, and utilizing a motion model, output a predicted trajectory corresponding to upcoming timestamps. A full predicted trajectory may be utilized to generate a local ROI.

The local ROI is computed using the sensing ranges encoded into a static mask 197 by mask generator 145. Static mask 197 defines a scene-agnostic classification of the area surrounding the ego-vehicle. For instance, a unique static mask 197 may be configured and known a priori for each vehicle configuration based on the sensor locations, sensor types, sensing ranges of the sensor(s) 108, etc. Alternatively, static masks 197 may be re-used for similar vehicle types. In some examples, a different orientation and size of the static mask may be utilized based on the vehicle operating in forward or reverse. Moreover, processing priority as indicated by static mask 197 may be altered based on the vehicle operating in forward or reverse. For instance, consider an example in which the vehicle is operating in reverse. An alternative static mask 197 may be automatically selected based on the reverse operating direction. In such an example, the area in close proximity to the rear of the vehicle and in a rearward direction may be indicated as having a highest priority, whereas an area in front of the vehicle may have a lower indicated processing priority. However, static masks 197 need not change based upon the operational environment through which a vehicle travels, hence the description of static mask 197 as scene-agnostic.

Both static mask 197 and dynamic mask 195 are merged by mask generator 213 into merged-mask 196 for the current frame. Mask generator 213 iteratively generates a new merged-mask 196 for each configured processing interval (e.g., each processing cycle, each time interval, each interval based on the frequency of sensor data, etc.). Static mask 197 may encode sensing ranges for the sensor(s) 108 and prioritizations for different zones, such as the area in front of a vehicle or the area behind the vehicle. Dynamic mask 195 encodes the dynamically obtained map data 166 corresponding to the current scene, such as the quantity of lanes, the lane types, and the intersecting roads relative to the current road for the ego-vehicle. The static mask 197 defines the local ROI as described below in relation to FIG. 5. The dynamic mask 195 defines the dynamic ROI which is the road information for the environment within which the ego-vehicle is operating. The merged-mask 196 is created by including any point, pixel, or region which is represented within both the static mask 197 and also the dynamic mask 195. If a portion of the dynamic mask 195 falls outside of the zones defined by the static mask 197, regardless of priority of those zones, then that portion of the dynamic mask will not be included in the merged-mask 196. Thus, a road segment, such as an intersecting crossroad with the current road, must be present within the dynamic mask 195 and also be located within at least one of the defined zones of the static mask 197, if that intersecting crossroad is to be included in the merged-mask. Any portion of the intersecting crossroad which cannot fully fit within at least one of the zones defined by the static mask 197 will be truncated wherever the intersecting crossroad extends beyond at least one of the defined zones of the static mask 197.

For instance, according to one example, processing system 100 (see FIG. 1) creates a dynamic mask from the dynamic ROI, creates a static mask from the local ROI, and creates a merged-mask corresponding to the combined ROI from regions of the dynamic ROI and the local ROI which are included within both the dynamic mask and the static mask.

Using the nomenclature of set theory, this means that merged-mask 196 will contain only the elements (pixels, points, bits, locations, etc.) that are present in both dynamic mask 195 and static mask 197. In other words, merged-mask 196 will have the bits set to 1 where both dynamic mask 195 and static mask 197 also have the bits set to 1 indicating presence within dynamic mask 195 and presence within static mask 197, respectively.

If the masks are represented as binary numbers or bit arrays, a bitwise AND operation may be applied to obtain the intersection of the two sets, where:

Merged-Mask 196=Dynamic Mask 195∩Static Mask 197.

As defined, a bitwise AND operation ensures that only the bits (e.g., pixels, points, portions, locations, etc.) that are 1 in both masks (e.g., present within dynamic mask 195 and present within static mask 197) are merged into merged-mask 196.

The combined ROI is determined from the merged-mask 196 which provides objects detected by the object detection DNNs 211 using the sensor data 167 which reside within the surviving portions of dynamic mask 195 and static mask 197 as merged into merged-mask 196 as per the intersection between the two sets (e.g., bits present in both dynamic mask 195 and static mask 197). The combined ROI also provides priorities for the multiple zones (e.g., in front of the vehicle, behind the vehicle, etc.) which were indicated by static mask 197 and the various dynamic road elements which were indicated by dynamic mask 195 obtained at least partially utilizing queries into a map database for map data 166. Mask generator 213 and/or orchestrator 245 may cause attribute processing DNNs 212 to only process attributes for previously-detected objects which reside within the combined ROI. For example, orchestrator 245 may selectively pass information only about the detected objects (e.g., pass the bounding boxes) for objects detected within the combined ROI to attribute processing DNNs 212 for further processing. Stated differently, any object previously detected within the scene by object detection DNN(s) 211 which does not reside within the more restrictive combined ROI will not be provided to attribute processing DNNs 212 for further processing by orchestrator 245 and/or mask generator 213. Moreover, orchestrator 245 may cause some subset of the objects within the combined ROI to undergo full attribute processing by attribute processing DNNs 212 (e.g., to derive all possible attributes) whereas other objects within the combined ROI will undergo limited processing by attribute processing DNNs 212, such as deriving an object's trajectory but not speed, pose, or collision risk.

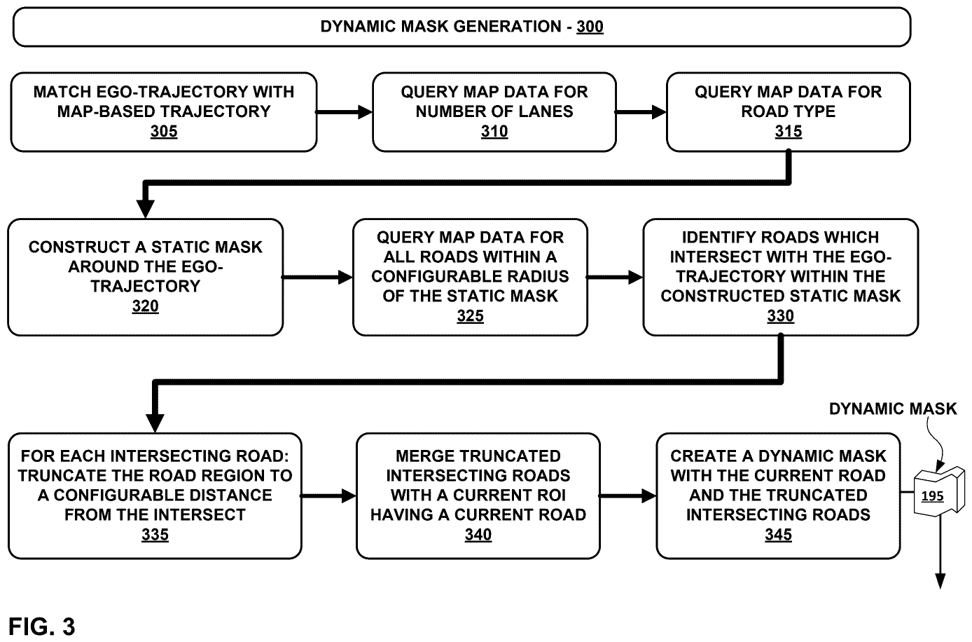

Generation of dynamic mask 195 is described in additional detail in relation to FIG. 3 below. An example of dynamic mask 195 is provided at FIG. 4 and described in additional detail below. An example of static mask 197 is provided at FIG. 5 and described in additional detail below.

A local coordinate system refers to a reference frame used to position and orient objects relative to the vehicle. The local coordinate system is defined based on the pose of the vehicle (e.g., the position and orientation of the vehicle in 3D space). By transforming dynamic and local regions of interest (ROIs) into the local coordinate system, mask generator 213 ensures that objects are correctly aligned relative to the vicinity of the vehicle. This allows mask generator 213 to accurately and programmatically merge data from dynamic and local ROIs, facilitating precise decision-making for tasks such as obstacle detection, navigation, and sensor fusion in ADAS 147 and autonomous driving systems utilizing object detection DNN(s) 211 and attribute processing DNN(s) 212 as depicted at FIG. 2.

In certain examples, orchestrator 245 may specify the order, sequence, and/or priority of processing utilizing prioritization unit 244, attribute dependencies 246, and occlusion handler 248.

Orchestrator 245 passes objects located within the combined ROI to attribute processing DNN(s) 112, 192 along with an indication processing priority for the objects. In some examples, orchestrator 245 may prioritize which attribute processing DNNs 212 are allocated higher processing priority. For example, orchestrator 245 may allocate highest priority to attribute processing DNN(s) 212 configured for VRU attribute detection. In other examples, orchestrator 245 may determine a sequence of attribute processing, determine which attributes are to be processed and in which order by attribute processing DNN(s) 212, or allocate higher priority processing to attribute processing DNN(s) 212 for a subset of the zones or portions of a scene. For instance, orchestrator 245 may prioritize a zone or region immediately in front of a vehicle with a highest priority such that any configured attribute is derived by attribute processing DNN(s) 212 for all objects in the prioritized zone. In such an example, orchestrator 245 may apply lower priority processing to, for example, a zone or region behind the ego-vehicle, such that only a subset of determinable attributes are derived by attribute processing DNN(s) 212 for objects detected behind the ego-vehicle. In a related example, orchestrator 245 may allocate no additional attribute processing DNN(s) 212 for a certain zone, such as an area beyond a threshold distance in front of the ego-vehicle where objects have been detected in the scene, but are not yet sufficiently relevant to provide higher priority processing as such objects will lack a sufficient likelihood of interacting with the ego-vehicle due to their relative distance from the ego-vehicle. Note that in a future processing cycle, the same object may be detected in a high priority zone due to the ego-vehicle moving forward toward that object or due to the object moving toward the ego-vehicle, or both. Assuming the object is again detected during a future processing cycle by object detection DNN(s) 211 and that object resides closer to the ego-vehicle within a higher priority zone, then orchestrator 245 may instruct attribute processing DNN(s) 212 to be applied to that object (during the future processing cycle), such that particular attributes may be derived, such as vehicle type, vehicle pose, vehicle trajectory, vehicle distance, and so forth. In such a way, information about an object may be derived utilizing computational resources when that object is relevant to the control of the ego-vehicle, and computational resources may be preserved or allocated to other tasks when the object lacks particular relevance or importance to the ego-vehicle (e.g., due to distance from the ego-vehicle, due to having position behind the ego-vehicle, due to a position on a non-intersecting road with the ego-vehicle, etc.).

Instead of running all neural networks concurrently, pre-processing is performed by applying object detection DNN(s) 211 to detect objects in a scene based on sensor data 167 (see FIG. 1). Subsequently, attribute processing DNNs 212 are selectively applied to determine attributes for some of the previously detected objects based on their presence within the combined ROI. For example, a combined ROI is created by merging a dynamic ROI with a local ROI. Relevant attributes are selected from the combined ROI by orchestrator 245 for computation based on the combined ROI which indicates different areas of the scene as having different processing priorities.

According to one example, processing system 100 (see FIG. 1) is configured to determine object types for a plurality of the objects detected within the scene and orchestrator 245 selects a subset of the object types for attribute determination. According to such an example, to determine the attributes for the one or more perception tasks for one or more of the objects detected within the combined ROI, processing system 100 (see FIG. 1) is further configured to apply the attribute determination to the selected subset of the object types using the one or more perception tasks for one or more of the objects detected within the combined ROI.

According to one example, orchestrator 245 is configured to determine at least a first-priority portion of the scene and a second-priority portion of the scene in the combined ROI and cause processing system 100 (see FIG. 1) to apply processing to the first-priority portion of the scene with a higher priority than processing applied to the second-priority portion of the scene. According to such an example, orchestrator 245 may cause processing system 100 (see FIG. 1) to process N attributes to derive a first set of attributes for objects within the first-priority portion of the scene and for objects within the second-priority portion of the scene and process fewer than N attributes to derive a second set of attributes for objects only within the first-priority portion of the scene.

As discussed above, different regions within the combined ROI may have different processing priorities. Attribute processing may be selectively applied, applied more to some areas and less to other areas, or not applied at all, to certain objects based on the processing priority. According to one example, to apply processing to the first-priority portion of the scene, processing system 100 (see FIG. 1) is further configured to process the N attributes to derive the first set of attributes for the objects within the first-priority portion of the scene, the first set of attributes are selected from a group including: spatial coordinates of one or more of the objects within the scene, relative distance from a sensor of the vehicle to one or more of the objects within the scene, directional heading of one or more of the objects within the scene, size or volume of one or more of the objects within the scene, and object classification of one or more of the objects within the scene. According to yet another example, to process fewer than the N attributes to derive the second set of attributes for the objects only within the first-priority portion of the scene, processing system 100 (see FIG. 1) is further configured to derive the second set of attributes for the objects only within the first-priority portion of the scene, wherein the second set of attributes are selected from a group including: speed at which one or more of the objects within the scene is moving relative to the vehicle, change in acceleration of one or more of the objects within the scene relative to the vehicle, occlusion detection for one or more of the objects within the scene relative to the vehicle, predicted trajectory of one or more of the objects within the scene relative to the vehicle, predicted future motion of one or more of the objects within the scene relative to the vehicle, hazard confidence score of one or more of the objects within the scene relative to the vehicle, collision risk of one or more of the objects within the scene relative to the vehicle, color of one or more of the objects within the scene, traffic signal type of one or more of the objects within the scene, traffic signal indication state of one or more of the objects, traffic signal relevancy of one or more of the objects within the scene relative to the vehicle, traffic sign type of one or more of the objects within the scene, traffic sign relevancy of one or more of the objects within the scene relative to the vehicle, inferred intent of one or more of the objects within the scene relative to the vehicle, drivable free-space for one or more portions of the scene relative to the vehicle, lane attributes of one or more of the objects within the scene, lane position of one or more of the objects within the scene, or road position context of one or more of the objects within the scene.

Orchestrator 245, depicted here as including prioritization unit 244, attribute dependencies 246, and occlusion handler 248, may specify which attributes are to be predicted and the order in which the attributes should be computed by attribute processing DNN(s) 212. For example, occlusion handler 248 of orchestrator 245 may evaluate whether the occlusion attribute should be computed by attribute processing DNN(s) 212 for objects within the combined ROI based on the processing priority for different areas of the combined ROI as indicated by merged-mask 196. For example, merged-mask 196 may indicate an area in front of the vehicle as high priority and an area behind the vehicle as a low priority. Based on the priorities, orchestrator 245 may instruct occlusion handler 248 to evaluate attribute dependencies 246 and resolve occlusions for objects within the combined ROI that reside in front of the vehicle only, despite there being other objects detected within the combined ROI behind the vehicle that may also be occluded. Occlusion handler 248 may responsively determine whether occlusion is below a certain threshold for the objects within the combined ROI that reside in the area in front of the vehicle. If the occlusion threshold is satisfied, attribute dependencies 246 may then be resolved, and occlusion handler 248 instruct attribute processing DNN(s) 212 to determine occlusion attributes for the relevant objects. Prioritization unit 244 of orchestrator 245 may manage other attribute dependencies 246, such as whether intent needs to be inferred for an object detected as a pedestrian or cyclist to subsequently compute a collision risk for that object.

Processing by attribute processing DNN(s) 212 may include identifying and computing specific attributes of objects detected within a scene in an order and/or based on a priority as specified by prioritization unit 244. Prioritization unit 244 may specify a level of processing to apply to various zones defined by the merged-mask 196 or an order in which to process attributes for the variously defined zones encoded by merged-mask 196. Processing by attribute processing DNN(s) 212 may also include identifying and computing specific numbers of attributes of objects such as occlusion, speed, and behavior. These attributes may be encoded into output 299 provided to ADAS 147 to enable ADAS 147 to interpret a scene in proximity of a vehicle and to make safe and informed driving decisions. By leveraging dynamic and local ROIs, attributes are processed in a sequence defined by orchestrator 245 based on their relevance and attribute dependencies 246. For example, the occlusion attribute may be computed first to assess object visibility, and if conditions are met, additional attributes are next evaluated. This approach enables efficient, context-aware decision-making, improving vehicle navigation and safety.

Orchestrator 245 may coordinate processing by attribute processing DNN(s) 212, including specifying which attribute processing DNN(s) 212 are to be applied to areas within the combined ROI, which attribute processing DNN(s) 212 are to be applied to which objects, the order in which attribute processing DNN(s) 212 are to be applied, how much computational resources are provided to which attribute processing DNN(s) 212, and so forth. For instance, orchestrator 245 may, by way of example, specify application of attribute processing DNN(s) 212 for all vehicles in mask 251, specify highest priority processing for cyclists in mask 253 and pedestrians in mask 252, selectively apply attribute processing DNN(s) 212 for drive zone in mask 255 and lane markings in mask 254 only for objects of the combined ROI detected within the forward, lateral left and lateral right regions of the combined ROI (e.g., lane markings and drive zones are not detected rearward of the vehicle). Continuing with this example, derived attributes 298 are subsequently provided as output 299 to a downstream application, such as ADAS 147 depicted here as a downstream application from object detection DNN(s) 211 and attribute processing DNN(s) 212.

For instance, according to one example, processing system 100 (see FIG. 1) is configured to define a first zone in proximity to the vehicle having a first direction and a first threshold distance from the vehicle, and define a second zone in proximity to the vehicle having one or both of a second direction different than the first direction and a second threshold distance from the vehicle different than the first threshold distance. According to another example, the first direction defined in proximity to the vehicle is a forward direction in relation to the vehicle and the first threshold distance from the vehicle is defined based on a sensing range of a forward-facing sensor of the vehicle from among the one or more sensors. According to this example, the processing system 100 (see FIG. 1) is further configured to apply processing to objects detected within the first zone with a higher priority than objects detected within the second zone. According to yet another example, the second zone defined in proximity to the vehicle includes one of: the second direction corresponding to a lateral left facing sensor in relation to the vehicle, the second direction corresponding to a lateral right facing sensor in relation to the vehicle, the second direction corresponding to a rear-facing sensor in relation to the vehicle, or the second threshold distance from the vehicle exceeding the first threshold distance from the vehicle for a forward-facing sensor oriented in the first direction. According to such an example, processing system 100 (see FIG. 1) is further configured to apply processing to the objects detected within the second zone with a lower priority than the objects detected within the first zone.

FIG. 3 is a flow diagram illustrating merged-mask generation process 300, in accordance with one or more techniques of this disclosure. The functions of the flow diagram of FIG. 3 may be implemented using mask generator 113, 193 and/or object detection DNN(s) 111, 191 and attribute processing DNN(s) 112, 192, of FIG. 1 and/or architecture 200 of FIG. 2 including object detection DNN(s) 211 and attribute processing DNN(s) 212.

As depicted by FIG. 3, dynamic-mask generation process 300 begins with block 305 to match an ego-trajectory with a map-based trajectory. For instance, the ego-trajectory is matched to OSM trajectories (e.g., based on map data 166 of FIG. 1) to obtain a trajectory centered within the middle of the lanes, ensuring the algorithm operates independently of the current lane of the ego-vehicle, allowing it to function successfully even if the ego-vehicle changes lanes.

Block 310 includes a query of map data for the number of lanes. Block 315 includes a query of map data for the road type. Block 320 constructs a static mask around the ego-trajectory (e.g., refer to static mask 197 of FIG. 1 and FIG. 2). For instance, for each segment of the trajectory, OSM (e.g., map data 166 of FIG. 1) is queried to determine the number of lanes and the road type. Based on the road type, the lane width is defined; for example, if the road type is classified as “highway,” the lane width is set to 4.5 meters. Using the lane count and lane width, a region of interest is constructed around the ego-trajectory, encompassing all objects in the same direction of travel as the ego-vehicle.

According to one example, the processing system 100 (see FIG. 1) is configured to: query the map data for a quantity of available lanes for each of a plurality of locations within the scene, query the map data for a road type corresponding to each of the plurality of locations within the scene, define a lane width based on the road type corresponding to each of the plurality of locations within the scene, and determine one or more of the available lanes correspond to a forward direction of travel and one or more of the available lanes correspond to an opposing direction of travel based at least in part on the quantity of available lanes and the lane width defined based on the road type. According to such an example, to determine the attributes for the one or more perception tasks for one or more of the objects detected within the combined ROI, the processing system 100 (see FIG. 1) is further configured to apply higher priority processing to the objects detected within the forward direction of travel than processing applied to the objects detected within the opposing direction of travel to derive a greater number of attributes for the objects detected within the forward direction of travel than the objects detected within the opposing direction of travel.

Block 325 includes a query of map data for all roads within a configurable radius of the static mask 197. Block 330 identifies roads which intersect with the ego-trajectory within the constructed static mask 197. To include intersecting roads in the region of interest, the ego-trajectory is down-sampled, and for each point, a circle with a predefined radius is created. For instance, to create the dynamic mask from the dynamic ROI, the processing system 100 (see FIG. 1) is configured to render a down-sampled variant of the predicted trajectory of the vehicle through the scene having a reduced quantity of points, and for each point in the down-sampled variant of the predicted trajectory, query the map data for all roads within a configurable search radius of a respective point. The ego-trajectory may be represented by a polyline which has a high number of points. Searching for neighboring roads utilizing OSM may include looping over the trajectory points, with each of the trajectory points considered as a center of a circle of a predefined radius (e.g., such as a circle having a radius of 500 meters). A specified circle using the predefined radius may be provided as input to OSM as part of a query requesting all roads that lie within the specified circle. Responsive to the query, OSM will return all roads within the specified circle, providing a mechanism by which to obtain neighboring roads. The query data returned by OSM may be filtered to determine which neighboring roads intersect with a road traveled by the ego-vehicle based on a current trajectory. However, since the current trajectory consists of a large number of points, querying all circles, even when limited by a predefined radius, will generate excessive overlap between the circles consuming excessive computational resources, data bandwidth, and time due to a large quantity of queries that would be triggered by the large number of points. More efficient use of computational resources may be enabled by first down-sampling the points within the current trajectory, creating a reduced number of points to be queried and reducing computational resources needed to determine which neighboring roads intersect with the road traveled by the ego-vehicle.

According to another example, processing system 100 (see FIG. 1) is configured to identify intersecting roads within the configurable search radius of each point in the down-sampled variant of the predicted trajectory that intersect with the predicted trajectory, truncate the intersecting roads to a threshold distance from the vehicle, and include the truncated intersecting roads within the dynamic mask.

Alternatively, a query to map data 166 (see FIG. 1) for all roads within a configurable search radius of the respective point may be utilized. In either case, OSM (e.g., map data 166 of FIG. 1) is queried using this radius to identify all roads within the circle or search radius. The identified roads are then filtered to retain only those that intersect with the ego-path. For instance, roads beyond the configured distance are not included and roads within the configured distance which do not intersect with the ego-path of the vehicle also will not be included.

At block 335, for each intersecting road, block 335 truncates the intersecting road region to a configurable distance from the intersect. Block 340 merges the truncated intersecting roads with a current ROI having a current road relative to the ego-vehicle. Block 345 creates a dynamic mask 195 (see FIG. 1 and FIG. 2) with the current road and the truncated intersecting roads. For instance, the intersecting roads are truncated to include only a specified margin within the region of interest, thereby discarding distant objects; for instance, a 100-meter segment, by way of example, may be configured for each intersecting road starting from the intersection point. The truncated intersecting roads are then merged into a current region of interest utilized to create dynamic mask 195. Consider, for instance, a lengthy road extending perpendicular to the ego-path of the vehicle. While the perpendicular road is included, the entirety of the perpendicular road need not be considered as doing so would waste valuable computational resources. Rather, only a configurable portion of the road is included, such as the first 100 meters of the road from the intersecting point with the ego-path of the vehicle is included and subjected to further processing. Obvious other distances may be configured depending upon the particular implementation details.

FIG. 4 is a diagram of an example dynamic mask 499, in accordance with one or more techniques of this disclosure. More particularly, FIG. 4 depicts variously defined characteristics of dynamic mask 499.

Traversable intersection 475 includes an intersection through which the vehicle may traverse according to map data 166 (see FIG. 1). Permissible path of travel 470 represents free-space upon a roadway through which the vehicle could conceivably travel, but may not necessarily travel. Permissible path of travel 470 is based at least in part on map data 166. Truncated roads 455 depict portions of roadways that are included within dynamic mask 499 due to intersecting with the predicted path of the ego-vehicle, but for which the road portions have been discarded or truncated due to being beyond a threshold distance from an intersecting point with the predicted path of travel for the vehicle. Stated differently, such truncated portions may lie beyond a configurable search radius and are therefore discarded. Map data with lane counts 485 depicts information queried for and obtained from map data 166 specifying at least a road type and a lane count for that segment of the road. Based on this information, a lane width may be calculated. Lane agnostic trajectory 460 depicts the line centered down the middle of the permissible path of travel 470 without being restricted to any particular lane of travel. Therefore, attributes may be calculated in a lane agnostic manner, and subsequent processing can handle lane specific considerations (e.g., such as a right turn only lane). Region beyond dynamic mask 465 is depicted as a black box beneath traversable intersection 475 indicating that information in that space may be disregarded as it is beyond the defined regions of dynamic mask 499, and as such, processing need not be applied to anything within that coordinate area.

According to one example, to determine the dynamic ROI based on a predicted trajectory of the vehicle through the scene using and based on the map data, the processing system 100 (see FIG. 1) is further configured to determine an ego-trajectory specifying future positions of the vehicle within the scene using at least previous pose data for the vehicle and a motion model for the vehicle relative to the scene. In such an example, the processing system 100 is configured to determine one or more map trajectories through the scene using the map data and a position of the vehicle within the scene, and obtain a lane agnostic trajectory having the vehicle centered within available lanes of the scene based on a matching between the ego-trajectory and the one or more map trajectories through the scene.

Dynamic mask 499 represents a dynamic trajectory-based ROI. Within dynamic mask 499, objects coincident with regions beyond dynamic mask 465 have been successfully excluded. Traversable intersection 475 was successfully expanded through the intersection due to increased vehicle interaction with the ego-vehicle. Permissible path of travel 470 indicates varying lane counts retrieved from OSM (e.g., map data 166) were successfully integrated, showing that the road initially had three lanes (two lanes and a merging lane) and, after the intersection, narrows to two lanes with reduced width. Mask generator 113, 193 (see FIG. 1) and mask generator 213 (see FIG. 2) dynamically may be configured to adjust dynamic mask 499 to accommodate these example changes.

FIG. 5 is a diagram of an example static mask 599, in accordance with one or more techniques of this disclosure. More particularly, FIG. 5 depicts variously defined regions of interests (ROIs) within static mask 599, including ROI 1 at element 501 immediately in front of the vehicle located at the center of the lower semi-circle, and ROI 2 at element 502 positioned immediately behind the vehicle. ROI 3 at element 503 is also in front of the vehicle, however, the region defined by ROI 3 at element 503 is depicted as residing beyond the sensing range 550, 551 of a forward-facing sensor of the vehicle or alternatively beyond distance defined for ROI 1 at element 501. ROI 4 at element 504 occupies the space within static mask 599 but outside of any of ROI 1, ROI 2, and ROI 3.

The horizontal axis depicts sensing range 550 which ranges from negative (−) 200 to positive (+) 200 in this particular example and the vertical axis depicts sensing range 551 ranging from negative (−) 300 to positive (+) 200 for this specific example. Other ranges are configurable depending on the type of sensor utilized and the manner in which the sensor is provisioned into a vehicle.

Static mask 599 is an ego-centric ROI (e.g., a local ROI or a static ROI) representing a scene-agnostic static mask 599 that defines a region of interest based on the sensing range 550, 551 without consideration of the characteristics of dynamic elements within the environment. Static regions ROI 1, ROI 2, ROI 3, and ROI 4 are established around the ego-vehicle to increase processing priority or to decrease processing priority of objects within them. ROI 1 at element 501, in this example, represents the most critical region, containing all objects posing a collision risk. ROI 2 at element 502, encompasses the area behind the ego-vehicle, and represents a lesser priority area where a reduced set of attributes is processed. ROI 3 at element 503 covers distant areas where certain attributes may be disregarded, and thus, some subset or limited group of attributes may be processed for objects within ROI 3 while discarding other attributes for objects within ROI 3, but simply are not needed. ROI 4 at element 504 includes regions with no interaction with the ego-vehicle, allowing attributes for objects detected within this region to be entirely ignored. The design of static mask 599 is dependent on the specific use case and may vary vehicle by vehicle, sensor by sensor, and according to requirements.

Static mask 599 may be curated manually for a given vehicle configuration based on sensing ranges defined for the one or more sensors of a vehicle (e.g., based on product specifications. However, in other examples, each static mask 599 may be configured automatically based on auto-populated sensing ranges obtained from a database specifying the sensor product information (e.g., sensing distance(s)) or based on configuration information unique to the vehicle platform or unique to a particular vehicle. For instance, diagnostics may test each of multiple sensors to determine a sensing range for each of one or more sensors (e.g., such as 50 feet or 100 feet, etc.). The determined sensing range may then be utilized to automatically configure static mask 599. For instance, a portion of a sensing range, such as 75%, for a forward-facing sensor may be configured as ROI 1 at element 501. Such a zone may be specified as a highest priority for the vehicle when moving in a forward direction. Another static mask 599 may utilize the same sensing distance but specify a lower priority for the vehicle when moving in a reverse direction with a zone behind the vehicle having a highest priority when moving in a reverse direction.

Areas in close proximity to the vehicle but laterally left and right of the vehicle may have a sensing range determined as, for example, 100 feet, however, due to the position of the sensors capturing sensor data in a lateral left and lateral right direction for left and right facing sensors, a smaller portion of the sensing range may be utilized, such as 5% or an absolute value, such as 10-feet, with a lower priority processing allocation. In such a way, objects within a threshold distance laterally left or right of the vehicle may undergo lesser attribute processing whereas objects beyond the threshold distance laterally left or right of the vehicle may be selectively eliminated from any attribute processing whatsoever to conserve limited computational resources.

A zone such as ROI 4 at element 504 which resides beyond a threshold distance from the vehicle may be designated as a lower priority as objects within that far away zone are unlikely to interact with the vehicle in the near term. Objects detected by object detection DNNs 211 (see FIG. 2) which reside within that far away ROI 4 zone may be tracked across frames or ignored entirely. Regardless, when objects that were previously within the far away ROI 4 zone encroach within the high priority ROI 1 zone, as detected during a current processing interval by object detection DNNs 211 (see FIG. 2), then such objects will selectively undergo more extensive attribute processing pursuant to the direction of orchestrator 245.

FIG. 6 is a diagram of an example merged-mask 650, in accordance with one or more techniques of this disclosure. More particularly, FIG. 6 depicts the resulting merged-mask 650 which is created by merging the points that are common to both dynamic mask 499 and static mask 599 into a single merged-mask 650. As described above, a pixel, point, bit, or location must be present in both dynamic mask 499 and also static mask 599 to be included in merged-mask 650. Any bit which resides within dynamic mask 499 but falls outside of any defined zone of static mask 499 will not be included in merged-mask 650. Merged-mask 650 encodes information from static mask 599, such as defined zones and priorities for those zones, information from dynamic mask 499, such as dynamic road elements obtained using map data 166 (see FIG. 1), and indicates objects previously detected by object detection DNN(s) 211 (see FIG. 2) which reside within a space defined by merged-mask 650 (e.g., associated with a bit, pixel, point, or location that is common to both dynamic mask 499 and also static mask 599).

Dynamic mask 499 may be transformed into a local coordinate system corresponding to each frame using a determined pose of the ego-vehicle. A dynamic ROI may be determined from dynamic mask 499. A local ROI may be determined from static mask 599. A combined ROI may be determined from merged-mask 650 to iteratively produce a single final merged-mask 650 for each current frame or each processing interval.

For instance, to create the combined ROI corresponding to merged-mask 650 from regions which are present in both dynamic mask 499 and also static mask 599, processing circuitry 110 may be configured to use mask generator 113, 193 (see FIG. 1) and mask generator 213 (see FIG. 2) to transform dynamic mask 499 into a local coordinate system using the determined pose of the vehicle. Mask generator 113, 193 (see FIG. 1) and mask generator 213 (see FIG. 2) may also be configured to merge or overlay static mask 599 onto the local coordinate system. Mask generator 113, 193, 213 may be configured to discard portions of dynamic mask 499 from the local coordinate system that do not share a coordinate position with the merged static mask 599. Mask generator 113, 193, 213 may then output the local coordinate system, with the portions of the dynamic ROI discarded, as merged-mask 650.

According to at least one example, to create the combined ROI from the merger of the dynamic ROI and the local ROI, processing system 100 (see FIG. 1) is further configured to transform the dynamic ROI into a local coordinate system using a determined pose of the vehicle, merge the local ROI into the local coordinate system, and discard portions of the dynamic ROI from the local coordinate system which lack a shared coordinate position with the local ROI merged into the local coordinate system. According to such an example, processing system 100 (see FIG. 1) is further configured to output the local coordinate system with the portions of the dynamic ROI discarded as the combined ROI. Alternatively, a static mask may be merged with a dynamic mask to generate a merged-mask. In such an example, the combined ROI may be determined from the merged-mask.

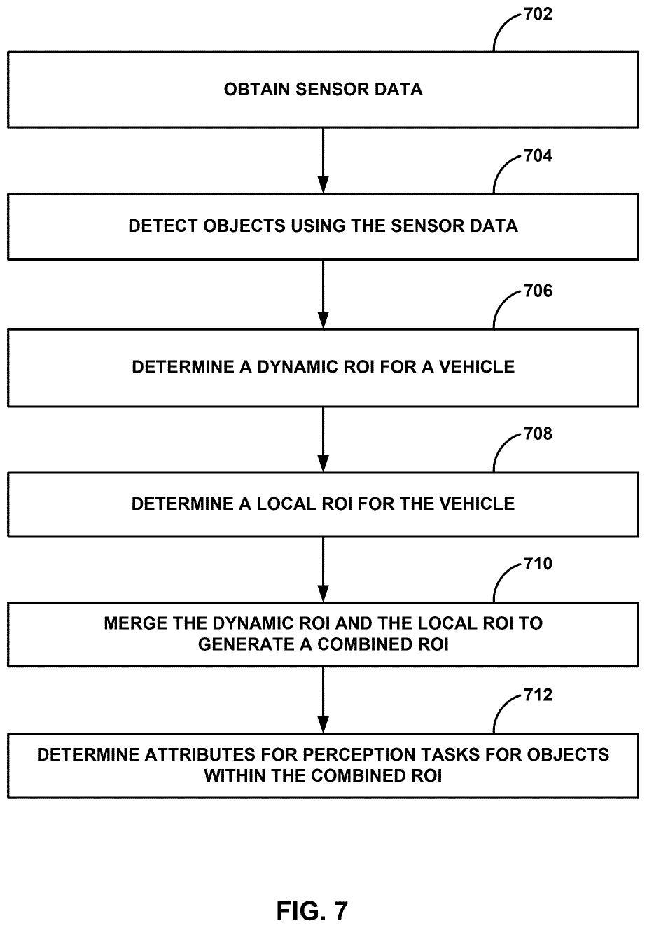

FIG. 7 is a flow diagram illustrating an example method for processing sensor data in a more efficient manner, in accordance with one or more techniques of this disclosure. FIG. 7 is described with respect to processing system 100 and external processing system 180 of FIG. 1, architecture 200 of FIG. 2, and the methods discussed in FIGS. 3, 4, 5, and 6. However, the techniques of FIG. 7 may be performed by different components of processing system 100, external processing system 180, architecture 200, or by additional or alternative systems.

Processing circuitry 110 may be configured to obtain sensor data 167 (702) and detect objects using the sensor data (704). For instance, processing circuitry 110 may be configured to obtain sensor data 167 from one or more sensors 108 (702), in which the sensor data corresponds to a scene in a vicinity of a vehicle and detect objects in the scene using the sensor data (704). Continuing with such an example, processing circuitry 110 may be configured to determine a dynamic region of interest (ROI) for a vehicle (706). For instance, processing circuitry 110 may be configured to determine a dynamic ROI based on a predicted trajectory of the vehicle through the scene using and based on map data 166 (706). According to this example, processing circuitry 110 may be configured to determine a local ROI for the vehicle (708). For instance, processing circuitry 110 may determine a local ROI for the vehicle using a sensing range 550, 551 of the one or more sensors 108 (708). Continuing with this example, processing circuitry 110 may be configured to merge the dynamic ROI and the local ROI to generate a combined ROI (710). According to this example, processing circuitry 110 may be configured to determine attributes for perception tasks for objects within the combined ROI (712). For instance, processing circuitry 110 may be configured to determine attributes for one or more perception tasks for one or more objects detected within the combined ROI (712).

Additional aspects of the disclosure are detailed in numbered clauses below.

Clause 1—An apparatus for performing a perception task, the apparatus comprising: a memory for storing sensor data; and processing circuitry in communication with the memory, the processing circuitry configured to: obtain sensor data from one or more sensors, the sensor data corresponding to a scene in a vicinity of a vehicle; detect objects in the scene using the sensor data; determine a first region of interest (ROI) based on a predicted trajectory of the vehicle through the scene; determine a second ROI for the vehicle based on a sensing range of the one or more sensors; merge the first ROI and the second ROI to generate a combined ROI; and perform one or more perception tasks using the combined ROI.

Clause 2—The apparatus of clause 1, wherein the first ROI is a dynamic ROI corresponding to a first field of view (FOV) of the one or more sensors at a first point in time different than a different dynamic ROI corresponding to a second FOV of the one or more sensors at second point in time.

Clause 3—The apparatus of clause 2: wherein the second ROI for the vehicle is a local ROI unchanged between the first point in time and the second point in time; and wherein to determine the first ROI based on the predicted trajectory of the vehicle through the scene, the processing circuitry is further configured to: create a dynamic mask from the dynamic ROI; create a static mask from the local ROI; and create a merged-mask corresponding to the combined ROI from regions of the dynamic ROI and the local ROI which are included within both the dynamic mask and the static mask.

Clause 4—The apparatus of clause 2, wherein to create the dynamic mask from the dynamic ROI, the processing circuitry is further configured to: render a down-sampled variant of the predicted trajectory of the vehicle through the scene having a reduced quantity of points; and for each point in the down-sampled variant of the predicted trajectory, query map data for all roads within a configurable search radius of a respective point.

Clause 5—The apparatus of clause 4, wherein to create the dynamic mask from the dynamic ROI, the processing circuitry is further configured to: identify intersecting roads within the configurable search radius of each point in the down-sampled variant of the predicted trajectory that intersect with the predicted trajectory; truncate the intersecting roads to a threshold distance from the vehicle; and include the truncated intersecting roads within the dynamic mask.

Clause 6—The apparatus of clause 2, wherein the processing circuitry is further configured to: create a static mask from the second ROI, wherein to create the static mask includes the processing circuitry further configured to: define a first zone in proximity to the vehicle having a first direction and a first threshold distance from the vehicle; and define a second zone in proximity to the vehicle having one or both of a second direction different than the first direction and a second threshold distance from the vehicle different than the first threshold distance.

Clause 7—The apparatus of clause 6: wherein the first direction defined in proximity to the vehicle is a forward direction in relation to the vehicle; wherein the first threshold distance from the vehicle is defined based on a sensing range of a forward-facing sensor of the vehicle from among the one or more sensors; and wherein the processing circuitry is further configured to: apply processing to objects detected within the first zone with a higher priority than objects detected within the second zone.

Clause 8—The apparatus of clause 6, wherein the second zone defined in proximity to the vehicle includes one of: the second direction corresponding to a lateral left facing sensor in relation to the vehicle; the second direction corresponding to a lateral right facing sensor in relation to the vehicle; the second direction corresponding to a rear-facing sensor in relation to the vehicle; or the second threshold distance from the vehicle exceeding the first threshold distance from the vehicle for a forward-facing sensor oriented in the first direction; and wherein the processing circuitry is further configured to: apply processing to the objects detected within the second zone with a lower priority than the objects detected within the first zone.

Clause 9—The apparatus of any one of clauses 1-8, wherein the processing circuitry is further configured to: determine object types for a plurality of the objects detected within the scene; select a subset of the object types for attribute determination; and apply the attribute determination to the selected subset of the object types using the one or more perception tasks for one or more of the objects detected within the combined ROI.

Clause 10—The apparatus of any one of clauses 1-9, wherein the processing circuitry is further configured to: process N attributes to derive a first set of attributes for objects within a first portion of the scene and for objects within a second portion of the scene; and process fewer than N attributes to derive a second set of attributes for objects only within the first portion of the scene.

Clause 11—The apparatus of clause 10, wherein to process fewer than the N attributes to derive the second set of attributes for the objects only within the first-priority portion of the scene, the processing circuitry is further configured to: derive the second set of attributes for the objects only within the first-priority portion of the scene, wherein the second set of attributes are selected from a group comprising: speed at which one or more of the objects within the scene is moving relative to the vehicle; change in acceleration of one or more of the objects within the scene relative to the vehicle; occlusion detection for one or more of the objects within the scene relative to the vehicle; predicted trajectory of one or more of the objects within the scene relative to the vehicle; predicted future motion of one or more of the objects within the scene relative to the vehicle; hazard confidence score of one or more of the objects within the scene relative to the vehicle; collision risk of one or more of the objects within the scene relative to the vehicle; color of one or more of the objects within the scene; traffic signal type of one or more of the objects within the scene; traffic signal indication state of one or more of the objects; traffic signal relevancy of one or more of the objects within the scene relative to the vehicle; traffic sign type of one or more of the objects within the scene; traffic sign relevancy of one or more of the objects within the scene relative to the vehicle; inferred intent of one or more of the objects within the scene relative to the vehicle; drivable free-space for one or more portions of the scene relative to the vehicle; lane attributes of one or more of the objects within the scene; lane position of one or more of the objects within the scene; or road position context of one or more of the objects within the scene.

Clause 12—The apparatus of clause 10, wherein the first set of attributes are selected from a group comprising: spatial coordinates of one or more of the objects within the scene; relative distance from a respective one of the one or more sensors of the vehicle to one or more of the objects within the scene; directional heading of one or more of the objects within the scene; size or volume of one or more of the objects within the scene; and object classification of one or more of the objects within the scene.

Clause 13—The apparatus of any one of clauses 1-12, wherein to perform one or more perception tasks using the combined ROI, the processing circuitry is further configured to: apply a neural network to the sensor data to determine attributes for the one or more perception tasks for one or more of the objects detected within the combined ROI; and determine, by the neural network, an output based on the attributes.

Clause 14—The apparatus of clause 13, wherein the processing circuitry and the memory are part of an advanced driver assistance system (ADAS), wherein the ADAS is configured to at least partially control the vehicle; and wherein the processing circuitry is further configured to: adjust an operating parameter of the ADAS based on the output.

Clause 15—The apparatus of any one of clauses 1-14, wherein the processing circuitry is further configured to: apply processing at a first priority for one or more regions of interest within the scene along the predicted trajectory of the vehicle through the scene where the vehicle satisfies a likelihood threshold of interacting with the scene.

Clause 16—The apparatus of any one of clauses 1-15, wherein to determine a first region of interest (ROI) based on a predicted trajectory of the vehicle through the scene, the processing circuitry is further configured to: determine the first ROI based on the predicted trajectory of the vehicle through the scene and based further on map data, sensor data, or both the map data and the sensor data.

Clause 17—The apparatus of clause 16, wherein to determine the determine the first ROI based on the predicted trajectory of the vehicle through the scene and based further on the map data, the sensor data, or both the map data and the sensor data, the processing circuitry is further configured to: determine an ego-trajectory specifying future positions of the vehicle within the scene using at least previous pose data for the vehicle and a motion model for the vehicle relative to the scene; determine one or more map trajectories through the scene using the map data and a position of the vehicle within the scene; and obtain a lane agnostic trajectory having the vehicle centered within available lanes of the scene based on a matching between the ego-trajectory and the one or more map trajectories through the scene.

Clause 18—The apparatus of clause 16, wherein the processing circuitry is further configured to: query the map data for a quantity of available lanes for each of a plurality of locations within the scene; query the map data for a road type corresponding to each of the plurality of locations within the scene; define a lane width based on the road type corresponding to each of the plurality of locations within the scene; and determine one or more of the available lanes correspond to a forward direction of travel and one or more of the available lanes correspond to an opposing direction of travel based at least in part on the quantity of available lanes and the lane width defined based on the road type.

Clause 19—The apparatus of any one of clauses 1-18, wherein the processing circuitry is further configured to: determine attributes for one or more objects detected within the combined ROI based on the one or more perception tasks; apply greater computational resources for processing objects detected within a forward direction of travel than computational resources applied to processing objects detected within an opposing direction of travel to derive a greater number of attributes for the objects detected within the forward direction of travel than the objects detected within the opposing direction of travel.

Clause 20—A method of processing sensor data comprising: obtaining sensor data from one or more sensors, the sensor data corresponding to a scene in a vicinity of a vehicle; detecting objects in the scene using the sensor data; determining a first region of interest (ROI) based on a predicted trajectory of the vehicle through the scene; determining a second ROI for the vehicle based on a sensing range of the one or more sensors; merging the first ROI and the second ROI to generate a combined ROI; and performing one or more perception tasks using the combined ROI.

Clause 21—A non-transitory computer-readable medium storing instructions that, when executed, cause processing circuitry to: obtain sensor data from one or more sensors, the sensor data corresponding to a scene in a vicinity of a vehicle; detect objects in the scene using the sensor data; determine a first region of interest (ROI) based on a predicted trajectory of the vehicle through the scene; determine a second ROI for the vehicle based on a sensing range of the one or more sensors; merge the first ROI and the second ROI to generate a combined ROI; and perform one or more perception tasks using the combined ROI.

Clause 22—A computer program product comprising one or more instructions that, when executed by at least one processor, cause the at least one processor to perform the method of clause 20.

Clause 23—The computer program product of clause 22, configured according to the apparatus of any of clauses 1-19.

Clause 24—A device comprising means for performing the method of clause 20.

Clause 25—The device of clause 24, configured according to the apparatus of any of clauses 1-19.

It is to be recognized that depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for performing a perception task, the apparatus comprising:
a memory for storing sensor data; and
processing circuitry in communication with the memory, the processing circuitry configured to:
obtain sensor data from one or more sensors, the sensor data corresponding to a scene in a vicinity of a vehicle;
detect objects in the scene using the sensor data;
determine a first region of interest (ROI) based on a predicted trajectory of the vehicle through the scene;
determine a second ROI for the vehicle based on a sensing range of the one or more sensors;
merge the first ROI and the second ROI to generate a combined ROI; and
perform one or more perception tasks using the combined ROI.

2. The apparatus of claim 1, wherein the first ROI is a dynamic ROI corresponding to a first field of view (FOV) of the one or more sensors at a first point in time different than a different dynamic ROI corresponding to a second FOV of the one or more sensors at second point in time.

3. The apparatus of claim 2:
wherein the second ROI for the vehicle is a local ROI unchanged between the first point in time and the second point in time; and
wherein to determine the first ROI based on the predicted trajectory of the vehicle through the scene, the processing circuitry is further configured to:
create a dynamic mask from the dynamic ROI;
create a static mask from the local ROI; and
create a merged-mask corresponding to the combined ROI from regions of the dynamic ROI and the local ROI which are included within both the dynamic mask and the static mask.

4. The apparatus of claim 2, wherein to create the dynamic mask from the dynamic ROI, the processing circuitry is further configured to:
render a down-sampled variant of the predicted trajectory of the vehicle through the scene having a reduced quantity of points; and
for each point in the down-sampled variant of the predicted trajectory, query map data for all roads within a configurable search radius of a respective point.

5. The apparatus of claim 4, wherein to create the dynamic mask from the dynamic ROI, the processing circuitry is further configured to:
identify intersecting roads within the configurable search radius of each point in the down-sampled variant of the predicted trajectory that intersect with the predicted trajectory;
truncate the intersecting roads to a threshold distance from the vehicle; and
include the truncated intersecting roads within the dynamic mask.

6. The apparatus of claim 2, wherein the processing circuitry is further configured to:
create a static mask from the second ROI, wherein to create the static mask includes the processing circuitry further configured to:
define a first zone in proximity to the vehicle having a first direction and a first threshold distance from the vehicle; and
define a second zone in proximity to the vehicle having one or both of a second direction different than the first direction and a second threshold distance from the vehicle different than the first threshold distance.

7. The apparatus of claim 6:
wherein the first direction defined in proximity to the vehicle is a forward direction in relation to the vehicle;
wherein the first threshold distance from the vehicle is defined based on a sensing range of a forward-facing sensor of the vehicle from among the one or more sensors; and
wherein the processing circuitry is further configured to:
apply processing to objects detected within the first zone with a higher priority than objects detected within the second zone.

8. The apparatus of claim 6, wherein the second zone defined in proximity to the vehicle includes one of:
the second direction corresponding to a lateral left facing sensor in relation to the vehicle;
the second direction corresponding to a lateral right facing sensor in relation to the vehicle;
the second direction corresponding to a rear-facing sensor in relation to the vehicle; or
the second threshold distance from the vehicle exceeding the first threshold distance from the vehicle for a forward-facing sensor oriented in the first direction; and
wherein the processing circuitry is further configured to:
apply processing to the objects detected within the second zone with a lower priority than the objects detected within the first zone.

9. The apparatus of claim 1, wherein the processing circuitry is further configured to:
determine object types for a plurality of the objects detected within the scene;
select a subset of the object types for attribute determination; and
apply the attribute determination to the selected subset of the object types using the one or more perception tasks for one or more of the objects detected within the combined ROI.

10. The apparatus of claim 1, wherein the processing circuitry is further configured to:
process N attributes to derive a first set of attributes for objects within a first portion of the scene and for objects within a second portion of the scene; and
process fewer than N attributes to derive a second set of attributes for objects only within the first portion of the scene.

11. The apparatus of claim 10, wherein the first set of attributes are selected from a group comprising:
spatial coordinates of one or more of the objects within the scene;
relative distance from a respective one of the one or more sensors of the vehicle to one or more of the objects within the scene;
directional heading of one or more of the objects within the scene;
size or volume of one or more of the objects within the scene; and
object classification of one or more of the objects within the scene.

12. The apparatus of claim 1, wherein to perform one or more perception tasks using the combined ROI, the processing circuitry is further configured to:
apply a neural network to the sensor data to determine attributes for the one or more perception tasks for one or more of the objects detected within the combined ROI; and
determine, by the neural network, an output based on the attributes.

13. The apparatus of claim 12, wherein the processing circuitry and the memory are part of an advanced driver assistance system (ADAS), wherein the ADAS is configured to at least partially control the vehicle; and
wherein the processing circuitry is further configured to:
adjust an operating parameter of the ADAS based on the output.

14. The apparatus of claim 1, wherein the processing circuitry is further configured to:
apply processing at a first priority for one or more regions of interest within the scene along the predicted trajectory of the vehicle through the scene where the vehicle satisfies a likelihood threshold of interacting with the scene.

15. The apparatus of claim 1, wherein to determine a first region of interest (ROI) based on a predicted trajectory of the vehicle through the scene, the processing circuitry is further configured to:
determine the first ROI based on the predicted trajectory of the vehicle through the scene and based further on map data, sensor data, or both the map data and the sensor data.

16. The apparatus of claim 15, wherein to determine the determine the first ROI based on the predicted trajectory of the vehicle through the scene and based further on the map data, the sensor data, or both the map data and the sensor data, the processing circuitry is further configured to:
determine an ego-trajectory specifying future positions of the vehicle within the scene using at least previous pose data for the vehicle and a motion model for the vehicle relative to the scene;
determine one or more map trajectories through the scene using the map data and a position of the vehicle within the scene; and
obtain a lane agnostic trajectory having the vehicle centered within available lanes of the scene based on a matching between the ego-trajectory and the one or more map trajectories through the scene.

17. The apparatus of claim 15, wherein the processing circuitry is further configured to:
query the map data for a quantity of available lanes for each of a plurality of locations within the scene;
query the map data for a road type corresponding to each of the plurality of locations within the scene;
define a lane width based on the road type corresponding to each of the plurality of locations within the scene; and
determine one or more of the available lanes correspond to a forward direction of travel and one or more of the available lanes correspond to an opposing direction of travel based at least in part on the quantity of available lanes and the lane width defined based on the road type.

18. The apparatus of claim 1, wherein the processing circuitry is further configured to:
determine attributes for one or more objects detected within the combined ROI based on the one or more perception tasks;
apply greater computational resources for processing objects detected within a forward direction of travel than computational resources applied to processing objects detected within an opposing direction of travel to derive a greater number of attributes for the objects detected within the forward direction of travel than the objects detected within the opposing direction of travel.

19. A method of processing sensor data comprising:
obtaining sensor data from one or more sensors, the sensor data corresponding to a scene in a vicinity of a vehicle;
detecting objects in the scene using the sensor data;
determining a first region of interest (ROI) based on a predicted trajectory of the vehicle through the scene;
determining a second ROI for the vehicle based on a sensing range of the one or more sensors;
merging the first ROI and the second ROI to generate a combined ROI; and
performing one or more perception tasks using the combined ROI.

20. A non-transitory computer-readable medium storing instructions that, when executed, cause processing circuitry to:
obtain sensor data from one or more sensors, the sensor data corresponding to a scene in a vicinity of a vehicle;
detect objects in the scene using the sensor data;
determine a first region of interest (ROI) based on a predicted trajectory of the vehicle through the scene;
determine a second ROI for the vehicle based on a sensing range of the one or more sensors;
merge the first ROI and the second ROI to generate a combined ROI; and
perform one or more perception tasks using the combined ROI.
